(19) United States
(12) Patent Application Publication
(10) Pub. No.: US 2022/0207122 A1
(43) Pub. Date: Jun. 30, 2022

(54) SYSTEM AND METHOD FOR MANAGEMENT OF DIGITAL MEDIA CONTENT

(71) Applicant: OPEN LENS PROJECT LTD., Reno, NV (US)

(72) Inventors: Randolph R. DAVIS, Reno, NV (US); Suzanne STEINMAN, Tehachapi, CA (US)

(21) Appl. No.: 17/695,641

(22) Filed: Mar. 15, 2022

Related U.S. Application Data
(63) Continuation of application No. 17/013,544, filed on Sep. 5, 2020, now abandoned.
(60) Provisional application No. 62/896,311, filed on Sep. 5, 2019.

(51) Int. Cl. G06F 21/31; G06F 16/2457

(52) U.S. Cl. CPC G06F 21/31; G06Q 2220/18; G06F 16/2457

(57) ABSTRACT

The present disclosure provides a system and a method for management of digital media content (DMC). The method includes providing, by a consumer, a token associated with a DMC. The method further includes authenticating the provided token to generate a DMC registration code for the DMC. The method further includes activating a license for the DMC corresponding to the generated DMC registration code. The method further includes triggering an action for a creator of the DMC in response to activation of the license therefor. The method further includes generating an access key for the DMC upon triggering of the action. The method further includes registering the generated access key for the DMC to the consumer.

### TECHNICAL FIELD

The present disclosure relates in general to digital content management, but not by way of limitation, to a system and method for registration, authentication, distribution, deployment, rendering and monetization of digital media content (DMC).

### BACKGROUND

Distribution of digital media content (DMC) has become widespread, and has been made highly efficient, and accessibility thereto has expanded, through digital distribution channels. This has led to increased sales and revenues for the content creators. However, certain classes of DMC, such as shorter segments or clips of existing media, are not seen as valuable in their own right i.e., it is not perceived as scarce, unique and limited. This is largely due to the fact that licenses to consume DMC are hard to control, and once disseminated are difficult to govern and monetize. Though there have been recent advances to make the DMC available on a limited-edition basis by means of blockchain or other authentication technology, video-based DMC (or other forms of DMC such as graphics or audio) is not offered with explicit per-unit licenses at the consumer level to apply to merchandise per se. That is, the rights to merchandize the video-based DMC for ownership on a discrete, per-unit basis is not available with known solutions. The value and utility of video-based DMC is therefore not fully realized with existing art and technology.

License for products, including a merchandise (such as a canvas or a mug) with licensed DMC, utilizing currently available art and technology, is mostly limited to a physical object to which the DMC is originally assigned. Present day technology does not allow for the consumer to take possession of the DMC and/or DMC license as a commodity in and of itself, including the merchandising license rights as owned on an discrete, per-unit basis, separate from and independent of the merchandise to which it has been or will be assigned. Utilizing current technology, if the assigned merchandise is lost, damaged, stolen or no longer desired by the consumer, the assigned DMC and any inherent merchandising rights, suffer the same fate. Furthermore, because the merchandise rights are not owned on a discrete, per-unit basis using current technology, the consumer does not have the option of reassigning the licensed DMC to new or different items of merchandise. These restrictions significantly limit the value and utility of the DMC license and merchandise for the consumer.

As mentioned, there is a growing trend to use blockchain for distribution, deployment and monetization of digital content such as digital currency and digital media content among others. However, using blockchain poses several challenges. For example, blockchain utilizes fixed identifiers for distributed items including digital content. Post-validation, a counterfeiter may skim the fixed identifier to unlawfully download the DMC to engage in unrestrained and unlicensed consumption. Further, public keys and external logs or ledgers of blockchain-based systems openly provide information about the distributed item and/or transaction, such as purchase price and identity of buyer and seller, at the expense of privacy. Additionally, external logs of blockchain expose DMC to theft or compromise from quantum computing attacks.

Currently available technology does not provide the means to effectively and economically control and monetize the distribution and application of licensed DMC to merchandise on a small scale. Consequently, so as to cover the costs for associated accounting, legal and other mechanisms, conventional licensing models are structured for high volume runs by a limited number of commercial enterprises rather than low volume runs by an unlimited number of consumers. In effect, this disenfranchises niche markets, creates lost opportunity for the licensor and licensee, and underserves the niche consumer. Further, the lack of currently available technology excludes all but highly-capitalized commercial enterprises in this arena for large-scale production, and limits the type of DMCs that can be viably brought to market, as the inability to monitor, document and compensate the licensor incrementally, for their intellectual property as it is consumed, forces the conventional licensing model to front-load payout of royalties.

Further, the lack of an incremental licensing mechanism makes consumer-curated merchandise creation, with sustaining merchandise ownership rights, unfeasible and impractical. The impracticalities of front-loaded licensing are evident throughout the industry where, for example, many of the stock footage providers (such as, Shutterstock) have resorted to offering an unlimited digital media usage license (as applied to one item or a million, e.g. by means of Augmented Reality (AR)), for an all-inclusive flat fee. Therefore, parties who may only need to use a small number of media items from such curated content would have to pay a hefty price per item, which may discourage them to purchase such content; and on the other side of the equation, parties who may use hundreds or thousands of media items from such curated content would have to pay relatively miniscule price per item, which in effect would undervalue and under-monetize the media for the content creator. Thus, such a model under-serves both the consumer and the content creator.

Therefore, there is a need of a mechanism for the creation and management of media license rights as discrete units that afford content creators novel protocols to monitor and control the disposition and character of licenses on a transparent, controlled and incremental basis.

### SUMMARY

In an aspect of the present disclosure, a method for management of digital media content (DMC) is provided. The method includes providing, by a consumer, a token associated with a DMC. The method further includes authenticating the provided token to generate a DMC registration code for the DMC. The method further includes activating a license for the DMC corresponding to the generated DMC registration code. The method further includes triggering an action for a creator of the DMC in response to activation of the license therefor. The method further includes generating an access key for the DMC upon triggering of the action. The method further includes registering the generated access key for the DMC to the consumer.

In one or more embodiments, the method further includes receiving, from the consumer, a merchandise profile associated with a merchandise; assigning a merchandise token to the merchandise based on the corresponding merchandise profile; authenticating the merchandise token to generate a merchandise registration code for the merchandise; registering the generated merchandise registration code for the merchandise to the consumer; and anchoring the access key associated with the DMC to the merchandise registration code associated with the merchandise for the consumer.

In one or more embodiments, the method further includes registering multiple access keys for corresponding multiple DMCs to the consumer; and allowing the consumer to selectively assign one or more of the multiple access keys to the merchandise registration code associated with the merchandise therefor.

In one or more embodiments, the method further includes recognizing the merchandise profile associated with the merchandise; retrieving the access key for the DMC anchored with the merchandise registration code associated with the merchandise having the recognized merchandise profile; and rendering the DMC in response to the retrieval of the access key thereof.

In one or more embodiments, the DMC is periodically updated. The method further includes rendering the updated DMC based on the retrieval of the access key thereof.

In one or more embodiments, the method further includes allowing the consumer to select a subset of the DMC having the access key registered therewith; allowing the consumer to generate a guest access key for the selected subset of the DMC; and rendering the selected subset of the DMC in response to retrieval of the guest access key.

In one or more embodiments, the method further includes the rendering of the selected subset of the DMC is controlled by one or more of physical proximity of a deployment device of the consumer, social network permissions and time limit on rendering of the selected subset of the DMC.

In one or more embodiments, the method further includes allowing the creator to set a limited number of the licenses for the DMC.

In one or more embodiments, the method further includes allowing the consumer to remove the anchoring of the access key associated with the DMC to the merchandise registration code associated with the merchandise.

In one or more embodiments, the method further includes allowing the consumer to transfer the access key associated with the DMC, as removed from the anchoring to the merchandise registration code associated with the merchandise, to be anchored to another merchandise registration code associated with another merchandise.

In one or more embodiments, the method further includes anchoring multiple access keys associated with corresponding DMCs to the merchandise registration code associated with the merchandise for the consumer; and queuing the DMCs, as associated with the multiple access keys, in a desired order to be rendered in response to the retrieval of the multiple access keys thereof.

In one or more embodiments, the triggering of the action for the creator of the DMC comprises triggering payment to the creator of the DMC based on the activated license for the DMC, out of proceeds from purchase of one or more of the DMC and the merchandise by the consumer.

In one or more embodiments, the registered access key is stored in a consumer token wallet associated with the consumer.

In one or more embodiments, the rendering of the DMC is in the form of one or more of Augment Reality (AR) rendering on the merchandise, and audio or video rendering on or off the merchandise.

In one or more embodiments, the rendering of the DMC is in the form of dynamic alteration of visual countenance of the merchandise, through digital overlays, as rendered on a deployment device by means of Augmented Reality, such that the rendering dynamically alters and regulates the visual countenance of the merchandise.

The foregoing summary is illustrative only and is not intended to be in any way limiting. Further areas of applicability of the present disclosure will become apparent from the detailed description provided hereinafter. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 depicts a system for management of digital media content, according to an embodiment of the present disclosure.

FIG. 2A depicts a method for generation, authentication and registration of royalty-based DMC from Merchandise, without IoT chips, according to an embodiment of the present disclosure.

FIG. 2B depicts a method for generation, authentication and registration of royalty-based DMC from Merchandise, with IoT chips, according to an embodiment of the present disclosure.

FIG. 2C depicts a method for generation, authentication and registration of non-royalty-based DMC from Merchandise, without IoT chips, according to an embodiment of the present disclosure.

FIG. 2D depicts a method for generation, authentication and registration of non-royalty-based DMC from Merchandise, with IoT chips, according to an embodiment of the present disclosure.

FIG. 2E depicts a method for generation and registration of royalty-based DMC from digital media content providers, according to an embodiment of the present disclosure.

FIG. 2F depicts a method for generation and registration of non-royalty-based DMC from digital media content providers, according to an embodiment of the present disclosure.

FIG. 2G depicts a method for generation and registration of royalty-based collectible DMC from digital media content providers, according to an embodiment of the present disclosure.

FIG. 2H depicts a method for generation, authentication and registration of tokenized Merchandise, according to an embodiment of the present disclosure.

FIG. 2I depicts a method for generation and registration of pre-tokenized DMC from Merchandise, according to an embodiment of the present disclosure.

FIG. 2J depicts a method for generation and registration of pre-tokenized DMC from digital media content providers, according to an embodiment of the present disclosure.

FIG. 3A depicts a method for distributing authenticated DMC for augmented reality rendering on anchored Merchandise, without IoT chips, according to an embodiment of the present.

FIG. 3B depicts a method for distributing authenticated DMC for augmented reality rendering on anchored Merchandise, with IoT chips, according to an embodiment of the present disclosure.

FIG. 3C depicts a method for distributing authenticated DMC for augmented reality rendering on unanchored Merchandise, without IoT chips, according to an embodiment of the present disclosure.

FIG. 3D depicts a method for distributing authenticated DMC for augmented reality rendering on unanchored Merchandise, with IoT chips, according to an embodiment of the present disclosure.

FIG. 3E depicts a method for streaming authenticated DMC for AR rendering directly from DMC/Access Cloud Server 180, according to an embodiment of the present disclosure.

FIG. 4A depicts a method for pairing/re-pairing Jukebox DMCs with selected Merchandise Media Channel(s), according to an embodiment of the present disclosure.

FIG. 4B depicts a method for pairing/re-pairing Jukebox DMCs with selected, tokenized Merchandise Media Channel(s), according to an embodiment of the present disclosure.

FIG. 4C depicts a method for pairing/re-pairing Tokenized DMCs with new/replacement tokenized Merchandise, according to an embodiment of the present disclosure.

FIG. 5 depicts a method for transferring DMC licenses from original licensee to new licensee, according to an embodiment of the present disclosure.

In the appended figures, similar components and/or features may have the same numerical reference label. Further, various components of the same type may be distinguished by following the reference label with a letter or letters or by following the reference label with a dash followed by a second numerical reference label that distinguishes among the similar components and/or features. If only the first numerical reference label is used in the specification, the description is applicable to any one of the similar components and/or features having the same first numerical reference label irrespective of the suffix.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Following are definitions of terms as used herein:
Digital Media Content (DMC) refers to either audio, video or static images which for the purposes of the present disclosure may include the license to consume DMC, or may further include licenses to merchandize DMC, the DMC itself, or Access Keys to DMC (whether tokenized or not).
Augmented Reality (AR) is a technology that superimposes a computer-generated image on a user's view of the real world, where the objects that reside in the real world are enhanced by computer-generated perceptual information, sometimes across multiple sensory modalities.
Access Keys are tokenized licenses that allow for the streaming of existing or yet-to-be-produced DMC.
Digital Authentication Technology (DAT) is a fast, secure, non-cryptographic, distributed authentication technology, not utilizing public ledgers.
Internet of Things (IoT) is a technology that identifies objects, reads and records metadata stored on chips, and controls individual targets when brought in proximity to the object equipped with compatible technology or any other similarly evolved purpose or technology.
Merchandise, herein, refers to household, personal or commercial goods, with intrinsic proprietary content or design.
Product, herein, refers to licensed DMC and Merchandise, collectively or individually.
Licensor, herein, refers to content creator/provider/owner, be a person or organization, of DMC who gives consumer (another person or organization) right to use DMC. Herein, the term “licensor” has been interchangeably used with terms “content creator,” “content owner,” “content provider,” “creator,” “owner,” “dealer” and “seller” without any limitations.
Licensee, herein, refers to consumer, be a person or organization, who has purchased a limited license to or who has been granted free access to the DMC by the content provider. Consumer can be end-customer, manufacturer or merchandizer depending upon the context. Herein, the term “licensee” has been interchangeably used with terms “consumer,” “customer,” “manufacturer” and “merchandizer” without any limitations.
Jukebox DMCs, also referred to as Channel DMCs, are digitally rendered content curated by the consumer from collections/albums of DMCs registered to the consumer.
Merchandise Media Channel, herein, refers to the use of dedicated AR-Ready Merchandise to render programmed DMC feeds or consumer-defined DMC albums.
Cooperative Manufacturing, herein, refers to the ability of the consumer to participate on a non-commercial scale in the manufacture of finished items of Merchandise, by contributing the value of their licensed DMC (or merchandise rights pertaining to the DMC) to the finished product.

In an aspect, the present disclosure provides a system for distributing authenticated digital content for augmented reality rendering. The system includes a database of accessible digital content comprising one or more licensed and verified DMCs, one or more items of merchandise, and a deployment engine for rendering the selected DMCs upon the GUI of the selected items of merchandise. The merchandise may include a near field transmission system for communicating a unique merchandise code, identifying and registering the item of merchandise, and securing the AR channel. The system also includes a) an authentication module for verifying DMCs and merchandise items, b) modules for identifying, registering and activating DMC licenses, and c) a pairing module to pair and unpair the various DMCs (discretely owned or otherwise) with the merchandise.

In another aspect, the present disclosure provides a method for deploying authenticated Digital Media Content (DMC) for Augmented Reality (AR) rendering. The method includes accessing a unique first code associated with an item of Merchandise and/or its DMC, verifying and converting the first code to a registration code, recording the item of Merchandise and associated DMC in the consumer's account, continually verifying and updating the registration code (as needed), deploying the authenticated DMC upon the registered item of Merchandise, or granting access to static or streaming DMC by virtue of the verified registration code, to obtain an augmented reality experience. Continually verifying and updating the registration code can confirm the authenticity and licensed status of the Merchandise and/or DMC. Alternatively, the license can be verified upon validation of the seller's rights to the Merchandise and/or DMC prior to any transfer of rights or ownership, or any confirmation of rights to apply the DMC to a new item of merchandise. The item of Merchandise comprises a) the Graphical User Interface (GUI) for rendering DMC, and b) a merchandise code stored on a chip or otherwise to authenticate the AR rendering feed. Further, this embodiment of verifying unique digital identities is not limited to any particular digital authentication technique or any one method of authentication or deployment but encompasses other applications such as blockchain. The present method also encompasses the authentication of the discrete rights to apply static images to merchandise. The present method can apply to the media itself, or to access keys to the content, each owned as a discrete unit, which can be distributed through digital devices independent of AR-applications (as if it were a ‘digital DVD’).

In an embodiment, the present disclosure provides a method for monitoring and incrementally monetizing DMC at the consumer level. With this method, once the merchandise and the DMC license have been authenticated and registered to the consumer, the processor activates the DMC license and triggers a royalty payment to licensor (content creator) out of proceeds from the purchase of the merchandise and/or the DMC. The activated license is then recorded in the consumer's accessible DMC database and is available for deployment.

In an embodiment, the present disclosure provides a method for generating limited-edition DMCs for direct digital distribution on conventional channels (e.g. digitally as played on a computer or tablet), or discrete, limited-edition rights to apply that media to merchandise (e.g.: #5 out of 50). through AR or other means of deployment. This method is initiated with the purchase of a limited-edition collectible DMC License which embodies one collectible license for distribution of the DMC on conventional channels, and a specified number of discrete, collectible licenses for distribution by means of AR rendering (or other means of deployment) upon merchandise. Once the collectible merchandise and DMC licenses have been authenticated and registered to the consumer, the processor activates the DMC licenses and triggers a royalty payment. The activated DMC and its associated license rights are then recorded in the consumer's accessible DMC database and are available for deployment, directly from files in the deployment device or by access to a server that stores that video content. This embodiment allows for intrinsic, explicit and discrete rights to apply DMC to merchandise. The novelty of this embodiment lies in the fact that the limited-edition status of the merchandise is governed by means of the tokenized media license, not the item of merchandise itself. In this manner, the collectible quality is inherently associated to the item of merchandise when the DMC license is assigned to that item.

In an embodiment, the present disclosure provides a method for rendering DMC upon the consumer's selection of merchandise, in the fashion of a jukebox. In this embodiment, the consumer indicates which of their available DMCs to pair with which item of merchandise currently residing in their account. The system creates the selected DMC/merchandise pairing and registers the new pairing in the consumer's account. The consumer brings associated deployment device into range of the merchandise. If not already authenticated the system authenticates the DMC and renders it upon the merchandise.

In an embodiment, the present disclosure provides a controlled environment for the consumer to incrementally create AR-ready merchandise for rendering of licensed DMC, on a Cooperative Manufacturing basis. Cooperative Manufacturing allows for transference of the licensed DMC, from one assigned item to another, within a protocol that recognizes the contribution of the unique and distinct economic value of the DMC. The administration, consumer-curation, deployment, sale and resale, mix and match of licenses, and marketing and monetization of content for creators of video (and static) DMC is governed in this embodiment of the present disclosure. This embodiment also provides an incremental licensing mechanism that helps make consumer-curated merchandise creation feasible and practical, due to the fact that the consumer explicitly owns the DMC merchandizing rights as a discrete unit of one and can deploy those license rights at their discretion. This includes the rights to apply static copyrighted material to merchandise, as well as video content through AR and other media categories.

In an embodiment, the present disclosure provides a method for facilitating decentralized authentication of a tokenized DMC license for the creation of merchandise. Herein, a merchandiser is provided with online access to a module with DAT functionality for the authentication of a tokenized DMC license, such that the licensee could submit the tokenized DMC license to the module. The control of the tokenized DMC is transferred from licensee to a distribution server, where the tokenized DMC license is authenticated using DAT, and the authentication status is transmitted to the merchandiser. The transfer event is logged with open-source protocols that allow the licensor to track consumption of the tokenized DMC. Further, payment to the licensor is triggered upon successful authentication. Thereafter, the control of the tokenized DMC is transferred from the distribution server to the licensee to allow for creating Merchandise with the tokenized DMC.

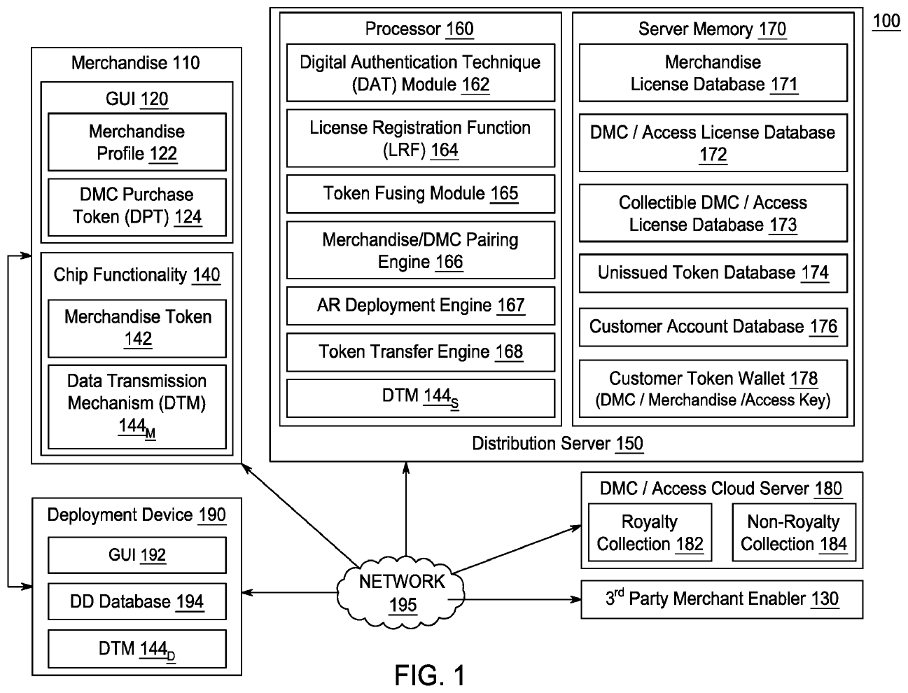

FIG. 1 depicts a System 100 for management of Digital Media Content (DMC), according to an embodiment of the present disclosure. System 100 includes one or more items of Merchandise 110, a 3^{rd} Party Merchant Enabler 130, a Distribution Server 150, one or more DMC/Access Cloud Server 180, a Deployment Device 190 and a Network 195 through which all components of System 100 are connected. System 100 of the present disclosure provides a novel and interactive platform for registration, authentication, distribution, deployment, rendering and monetization of digital media content (DMC). The technique described herein enables content providers to monetize underutilized DMC, for example, prime excerpts from popular video footage, to capture revenue lost through conventional distribution channels (e.g., stock footage licensing platforms that don't optimize returns), and to multiply revenue streams (e.g., through ads, merchandising, upselling, etc.). System 100 further provides ability to mix and match the pairing of a variety of licensed DMCs (with merchandise rights or without) with a variety of merchandise items, curated at the consumer level. System 100 provides an economical means for content creators to effectively monitor and be compensated for licensed merchandise media consumption on a controlled and incremental basis.

Merchandise 110 may include any type of object such as, but not limited to, mugs, plates, magnets, canvas prints, towels, t-shirts, hats, jackets, hoodies, mousepads, posters, book covers, lunch boxes, stickers, backpacks, sports bottles, a wall, a decal, a person, or any surface (pre-defined or otherwise) on which DMC may be rendered. In one or more embodiments, Merchandise 110 is Augmented Reality-ready (AR-ready), and images are associated and applied, to activate videos through Augmented Reality. The AR-ready Merchandise 110 includes a Graphical User Interface (GUI) 120 which incorporates a Merchandise Profile 122 and a DMC Purchase Token (DPT) 124. In some embodiments, Merchandise 110 further includes a Chip Functionality 140 which incorporates a Data Transmission Mechanism (DTM)144_{M} and may incorporate a Merchandise Token 142, described in further detail below, and/or a Merchandise Profile 122. Herein, subscript ‘M’ is used for reference to Merchandise. GUI 120 includes one or more images embedded or otherwise attached to Merchandise 110, some of which are designed to trigger a dedicated audio/video feed of DMC, so that it appears to be playing directly on the Merchandise 110 to provide an AR experience for the Licensee. Alternatively, GUI 120 may be used to render DMCs on Merchandise 110 (audio and/or video), in a manner that is asynchronous with the image depicted on the item. GUI 120 may encompass graphical interfaces along the lines of QR Codes, outside of any audio/video-trigger functionality.

GUI 120 includes a Merchandise Profile 122 which identifies the type of merchandise, and a DMC Purchase Token (DPT) 124 which first identifies and later authenticates the DMC license associated with Merchandise 110 and may be a token itself or the precursor or index to a token housed within Distribution Server 150. Merchandise Profile 122 may be embedded in GUI 120 or may reside on a chip with electronic storage mechanism and utilizing, for example Near Field Communication (NFC) and/or Bluetooth Low Energy (BLE) based communication, according to one embodiment. Though DPT 124 is depicted as independent of Chip Functionality 140, DPT 124 may reside on the same or a different chip or may be embedded in a graphical user interface, such as a QR code. Merchandise Token 142, housed in Chip Functionality 140, serves to identify and authenticate Merchandise 110 and may be a token or the precursor or index to a token which is housed within Distribution Server 150. Data Transmission Mechanism (DTM) 144_{M}, residing in Chip Functionality 140, may use NFC, Bluetooth Low Energy (BLE), or other electronic transmission mechanisms that allow Merchandise 110 to transmit data. Similarly, a DTM 144_{D} is included in Deployment Device 190 (herein, subscript ‘D’ is used for reference to Deployment Device), and further a DTM 144_{S} is included in Distribution Server 150 (herein, subscript ‘S’ is used for reference to Distribution Server), to enable the exchange of data among the various devices through short- and/or long-range communication techniques.

3^{rd} Party Merchant Enabler 130 includes an e-commerce platform (along the lines of Shopify™, BigCommerce™ and Volusion™) to enable selling of DMCs. 3^{rd} Party Merchant Enabler 130 may provide dedicated tools to sell digital media content, offer subscriptions, secure digital rights management, and even sell physical items, along with providing administration, transaction, customer service facilities and merchant services.

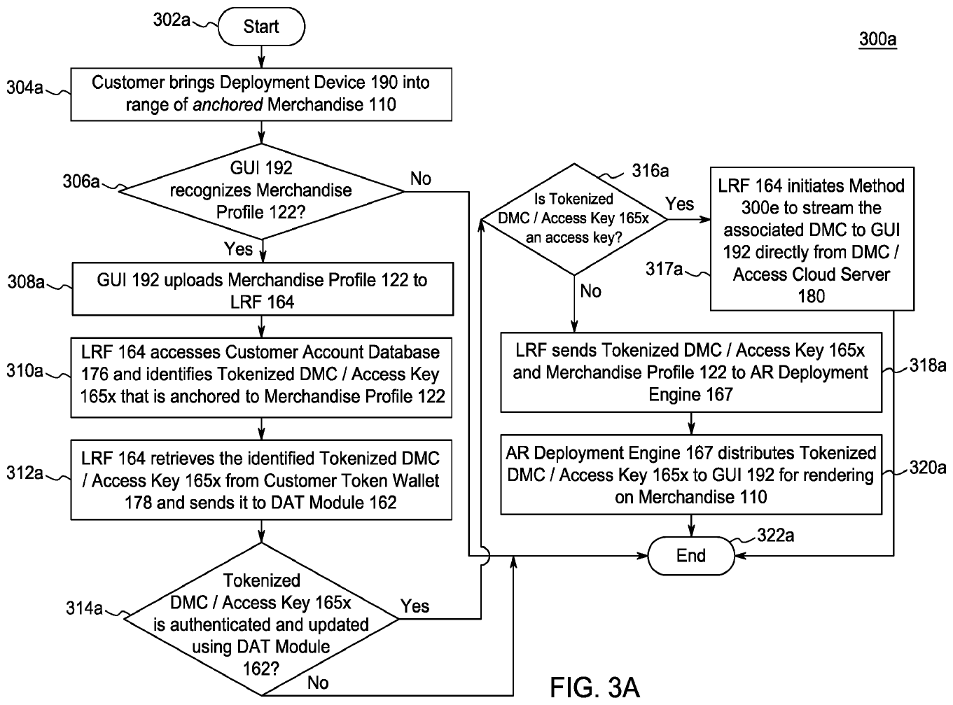

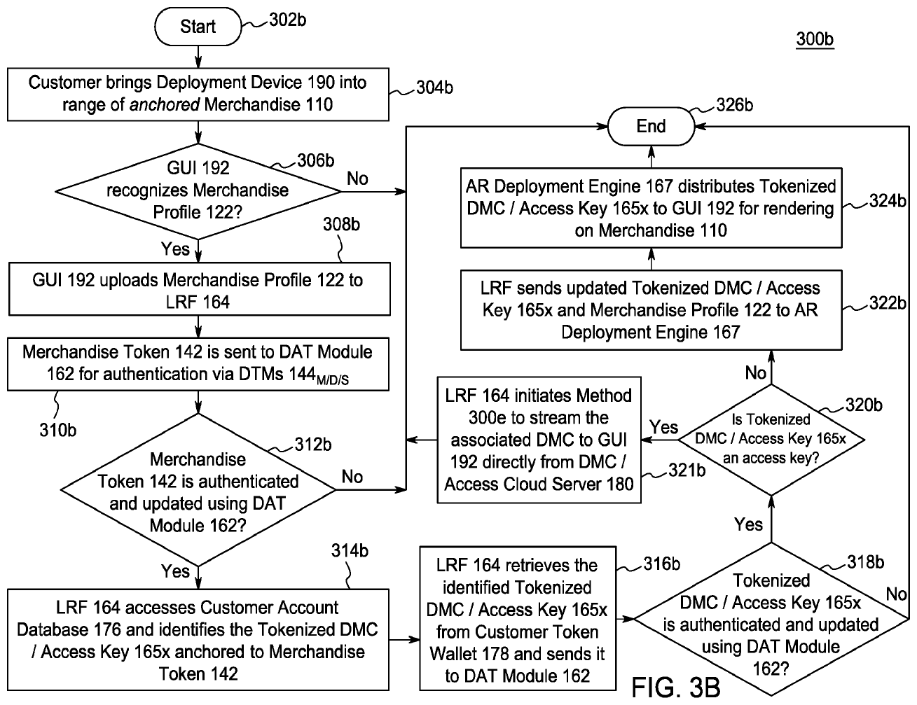

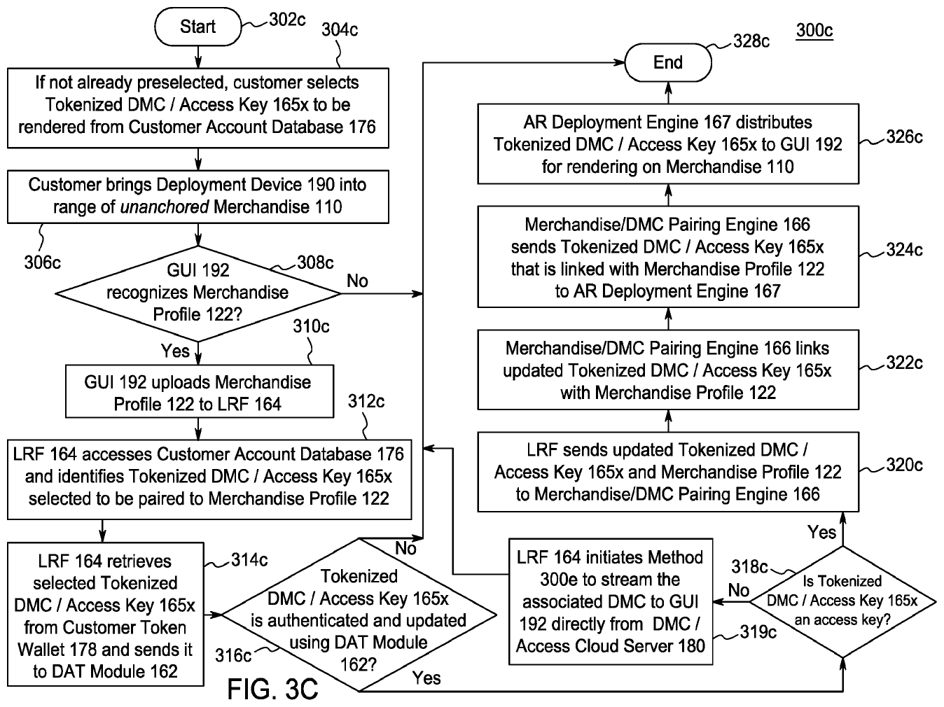

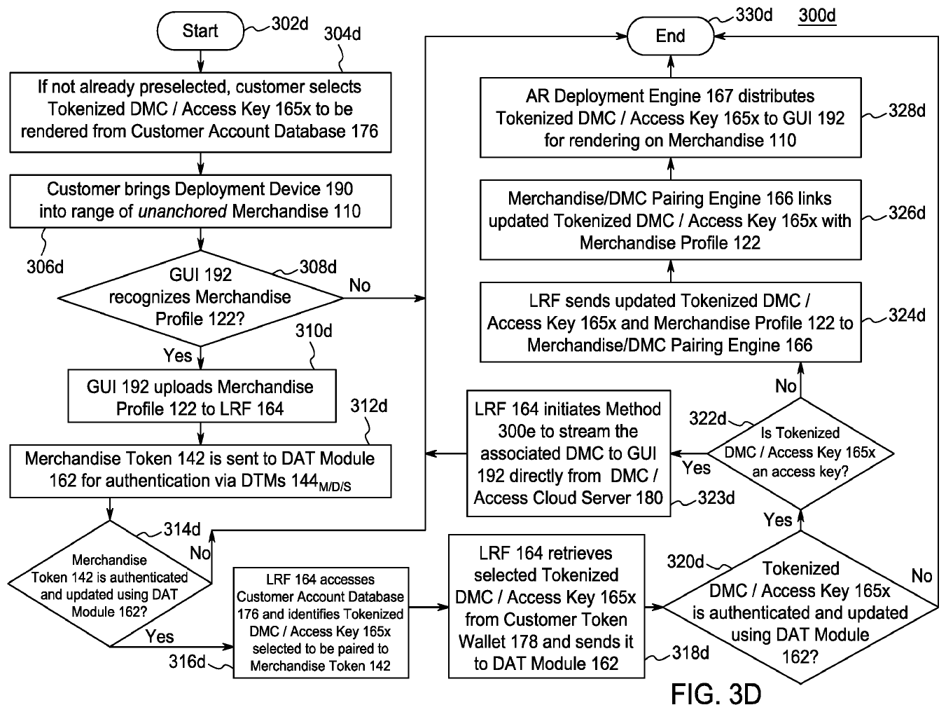

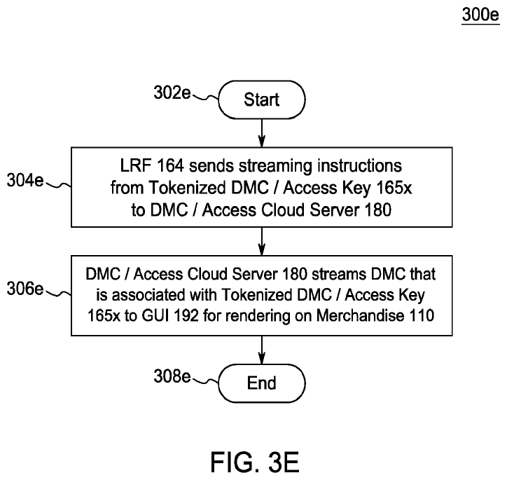

Distribution Server 150 includes a Processor 160 and a Server Memory 170. Processor 160 includes a Digital Authentication Technique (DAT) Module 162, a License Registration Function (LRF) 164, a Token Fusing Module 165, a Merchandise/DMC Pairing Engine 166, an AR Deployment Engine 167, a Token Transfer Engine 168, and DTM 144_{S} as mentioned above. A GUI 192 of Deployment Device 190 interacts with AR Deployment Engine 167 to enable interaction and communication between the consumer (not shown), Merchandise 110 and Distribution Server 150. The method of operation of AR Deployment Engine 167 is described in detail with reference to Methods 300A-300E of FIGS. 3A-3E. In one embodiment, Merchandise Profile 122 of Merchandise 110 is communicated to Distribution Server 150 via Deployment Device 190.

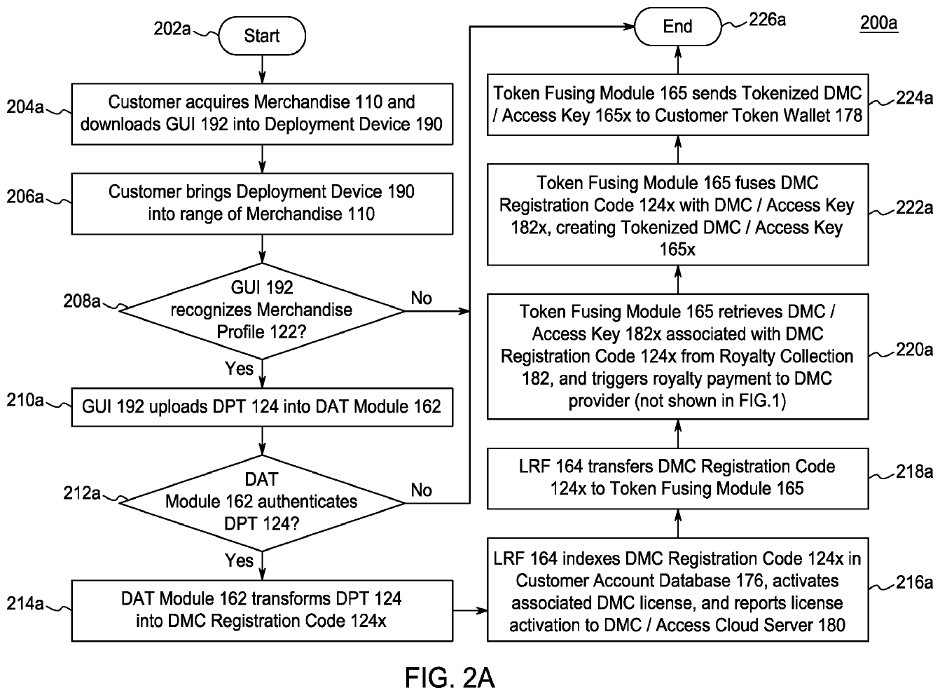

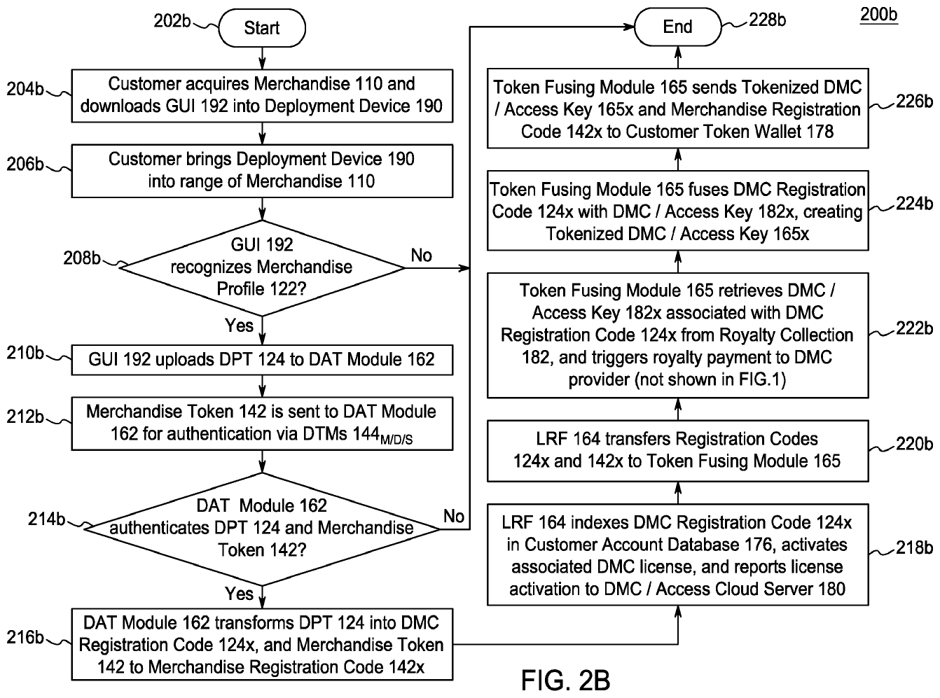

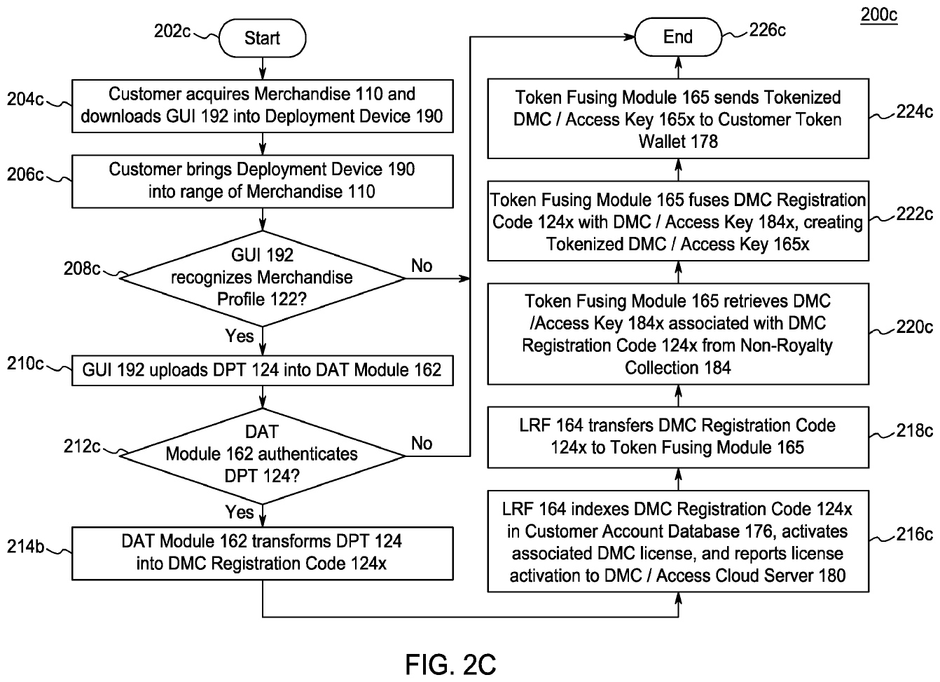

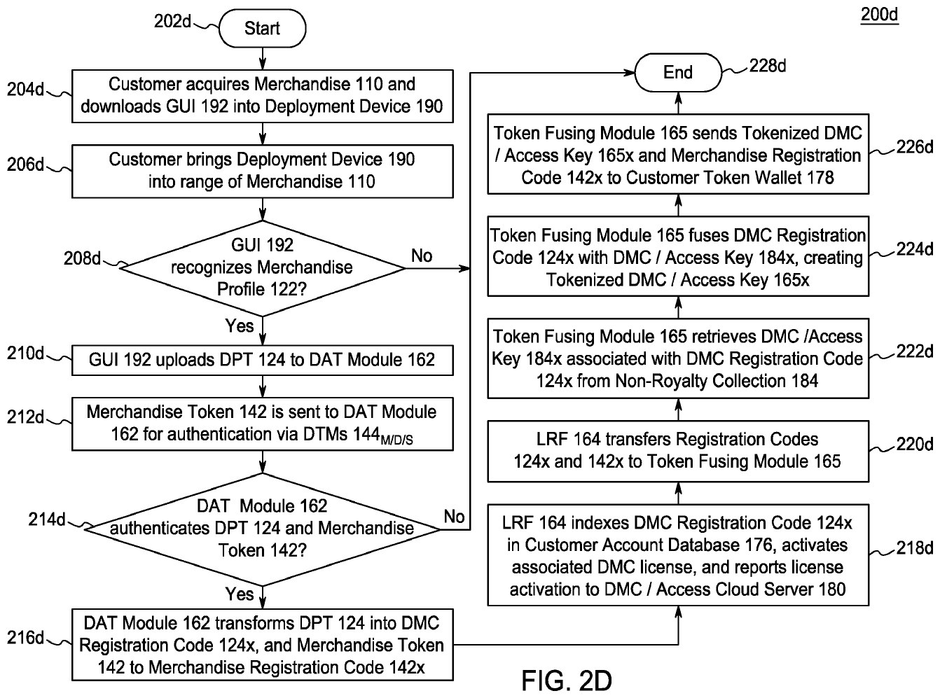

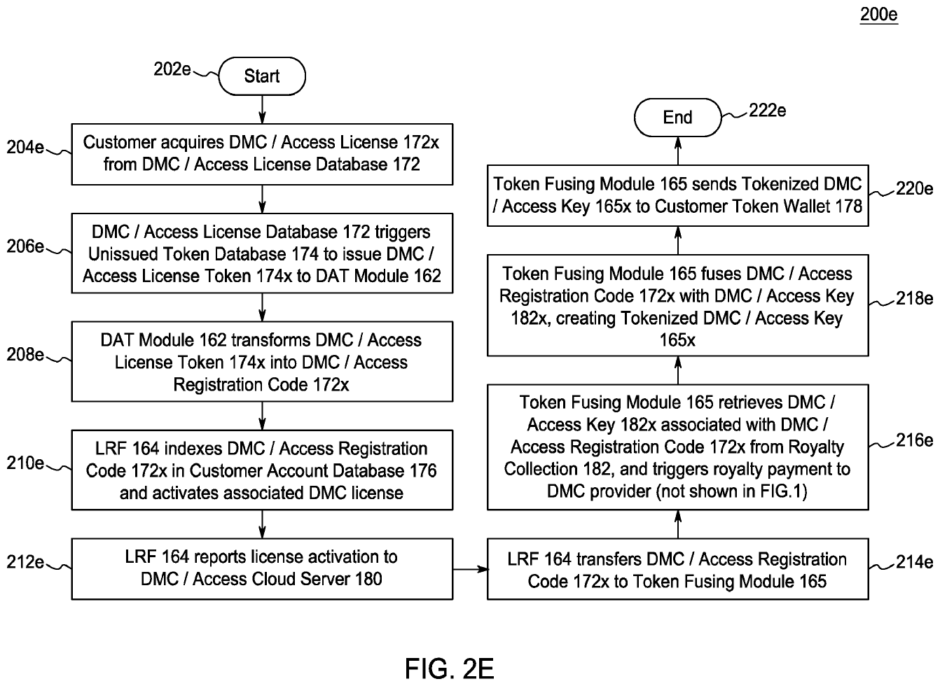

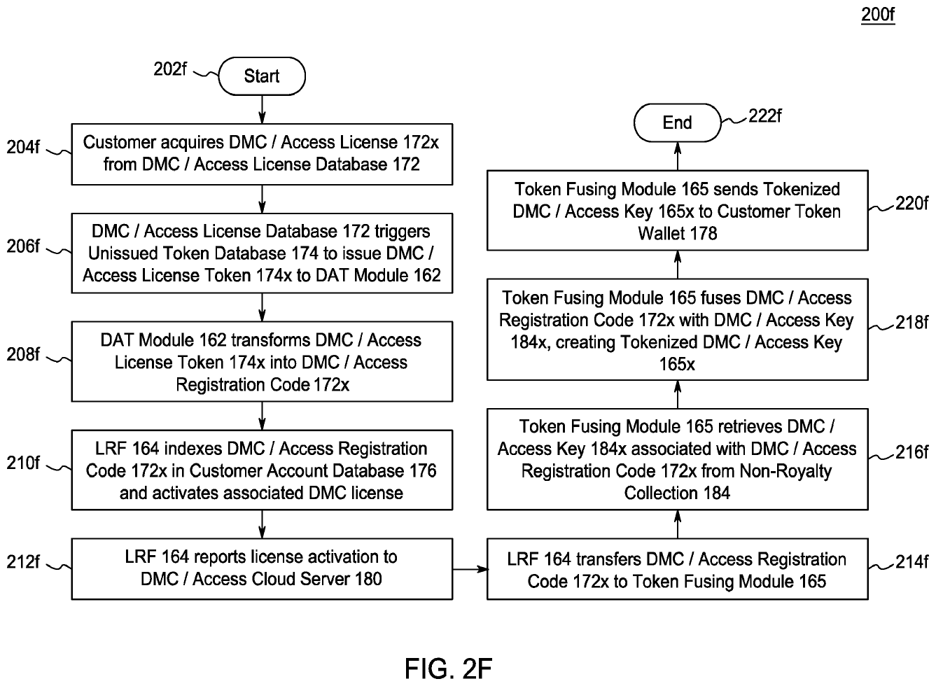

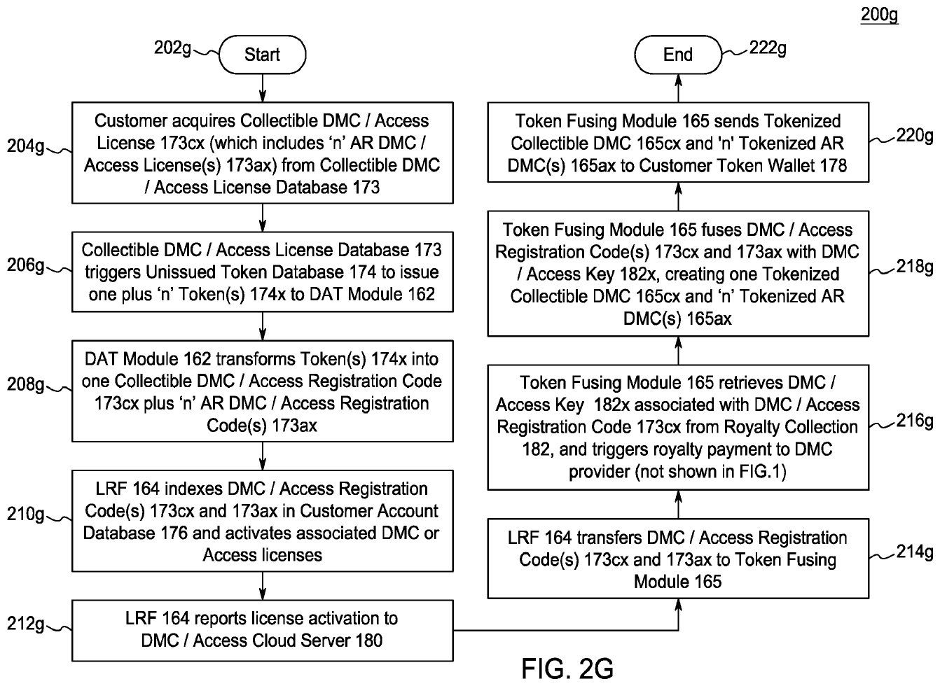

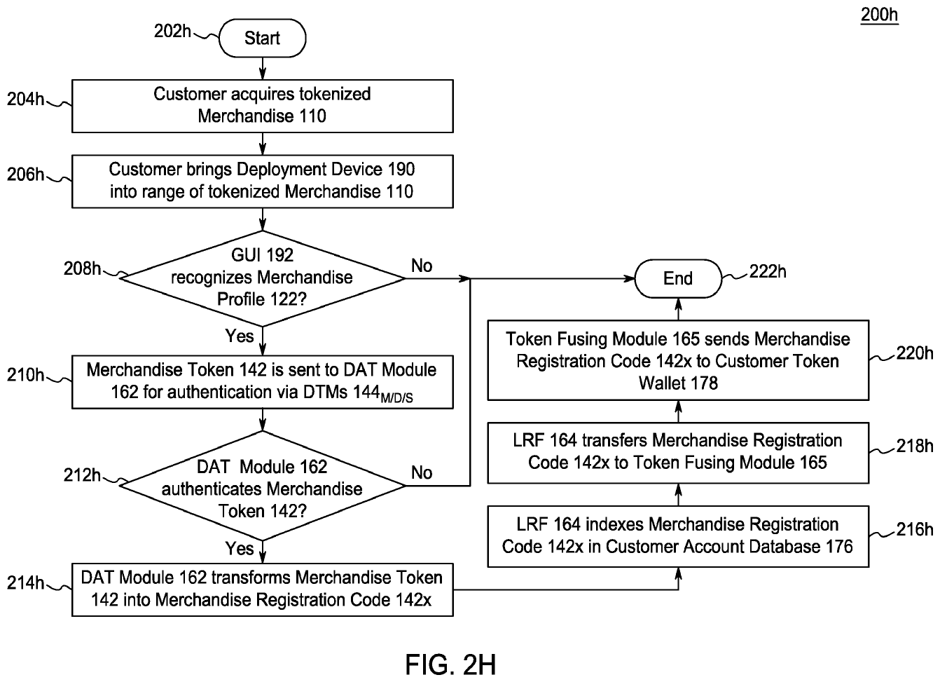

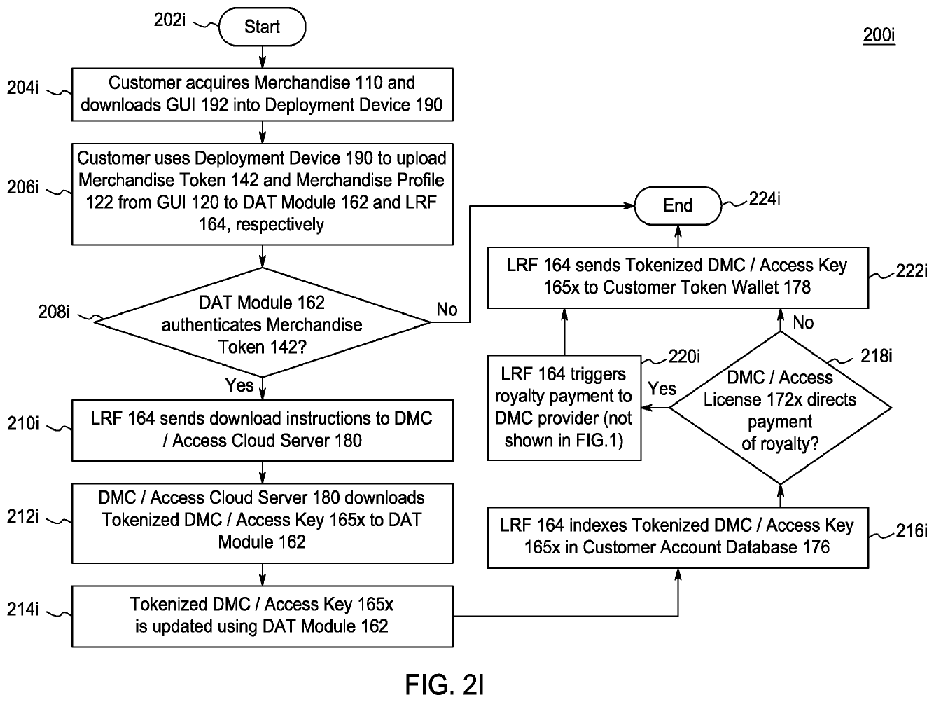

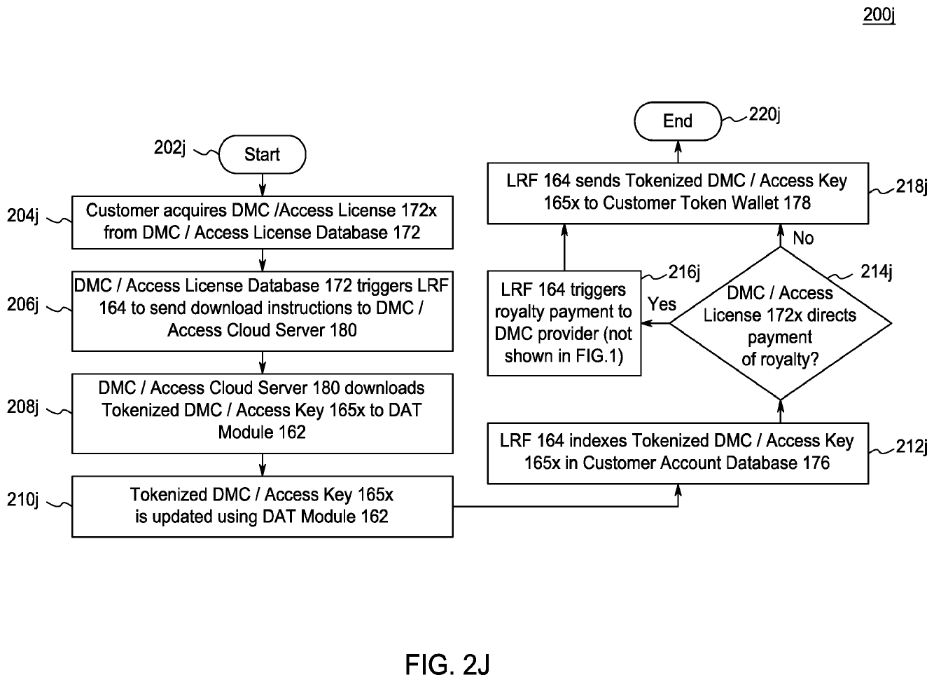

Server Memory 170 includes a Merchandise License Database 171, a DMC/Access License Database 172, a Collectible DMC/Access License Database 173, an Unissued Token Database 174, a Customer Account Database 176 and a Customer Token Wallet 178 (or “Wallet”) for storage of the consumer's registered tokenized DMC, Merchandise and Access Key licenses. Merchandise License Database 171 includes an index of Merchandise Profiles 122 that are recognized by and incorporated into System 100. DMC/Access License Database 172 includes an index of one or more discrete or streaming DMCs, which have been offered by the copyright owners for licensed use and AR deployment. Collectible DMC/Access License Database 173 includes an index of one or more DMCs, which have been offered on a limited-edition basis by the copyright owners in various capacities, such as: a) digital memorabilia in their own right, or b) for AR deployment on Merchandise. Discrete DMC (Collectible or not) refers to any singular, stand-alone unit of DMC. Streaming DMC (Collectible or not) refers to any singular or ongoing series of DMCs of a specified nature which, with the proper tokenized Access Keys, may be streamed from DMC/Access Cloud Server 180 to Merchandise Media Channel(s) associated with the DMC. Unissued Token Database 174 is a cache of specifically constructed DAT Tokens which are utilized by System 100 for authentication and digital rights management (DRM). Customer Account Database 176 includes a listing of all consumers registered with System 100. The database may be a simple list or in the form of a relational database with each consumer having a unique ID or identifier. Customer Account Database 176 also stores all account information associated with each consumer, such as their profile, subscription model, preferences, and a catalog, album or index that points to the consumer's Wallet. Customer Token Wallet 178 is a specialized type of database that holds all of the consumer's licensed, tokenized DMCs (or indexes thereto), such as excerpts, videos and vines, as well as Access Keys (which grant access to streaming singular or ongoing DMCs) both represented by this invention as Tokenized DMC/Access Key 165x (described in detail with reference to FIGS. 2A-2G and 21-2J). Customer Token Wallet 178 also holds all of the consumer's licensed, tokenized Merchandise. Customer Account Database 176 and Customer Token Wallet 178 may be stored in Server Memory 170 and accessed by Deployment Device 190, or may be stored on Deployment Device 190, or a combination of both. DMCs may be licensed to the consumer on a per-DMC basis, or by subscription to regularly issued content or to a catalog of existing DMCs utilizing Access Keys. All DMC licenses registered to the consumer form the Customer's Wallet. Customer Token Wallet 178 may house all accessible DMCs or may consist of indices to DMCs stored on DMC/Access Cloud Server 180. It may be housed within Server Memory 170, or in another embodiment, may be housed in a separate, dedicated server. The method of generation of Customer Token Wallet 178 is described in detail with reference to methods 200a-200j of FIGS. 2A-2J.

DMC/Access Cloud Server 180 supplies licensed DMC to System 100. Licensed DMC may be supplied upon purchase, gratis, lease, on demand, at regular intervals (such as daily, weekly or monthly), irregularly, for a limited time, or on a subscription basis. DMC/Access Cloud Server 180 includes Royalty Collection 182 and Non-Royalty Collection 184. Royalty Collection 182 is a collection of royalty-based DMC and Access Key licenses. Non-Royalty Collection 184 is a collection of non-royalty-based DMC and Access Key licenses. In one embodiment, DMC/Access Cloud Server 180 with its DMC and Access Key content is held in escrow and issues DMC and Access Key licenses to Distribution Server 150 in lieu of transferring the entire body of DMCs and Access Keys to the license databases of Server Memory 170. In another embodiment, DMC/Access Cloud Server 180 may be hosted on third-party platforms along the likes of YouTube or Vimeo.

Deployment Device 190 includes a GUI 192, a Deployment Device (DD) Database 194, and DTM 144_{D} (as mentioned above). GUI 192 interfaces with AR Deployment Engine 167 on Processor 160 to render DMCs via GUI 120 of Merchandise 110, or directly on Deployment Device 190. In one embodiment, the consumer's entire accessible DMCs and Access Keys may reside in DD Database 194. In various embodiments, DD Database 194 may house all or part of the consumer's accessible DMCs and Access Keys, merchandise information, account information, and/or other information. In one embodiment, the information housed in DD Database 194 may be a duplicate of all or part of the information residing in Server Memory 170. In one embodiment, DMC that is held in DD Database 194 may be rendered on Merchandise 110 offline, without accessing Network 195. Access Keys cannot be used to render content offline as they require connection with DMC/Access Cloud Server 180 to render the associated DMCs. DTM 144_{D} functionality is described above. Deployment Device 190 may be a smart device, handheld, head-mounted or otherwise, and GUI 192 of Deployment Device 190 may be in the form of an App (smartphone application, such as iOS™ and/or Android™ app), a webpage, or other suitable modality as may be contemplated by a person skilled in the art.

Network 195 refers to the internet or other electronic networking system and serves as a communication hub to allow all components of System 100 to interact and transact with one another. In one or more examples, Network 195 may implement a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol. In one embodiment, Deployment Device 190 and Merchandise 110 may interact directly with each other via their DTMs 144 rather than Network 195.

Embodiments of the present disclosure provides a method for management of digital media content (DMC). The method includes providing (accessing), by a consumer, a token associated with DMC. Herein, the “token” may be DPT 124 or DMC/Access License Token. The method further includes authenticating the provided (accessed) token to generate DMC registration code for the DMC. The method further includes activating a license for DMC corresponding to generated DMC registration code. The method further includes triggering action for a creator of DMC in response to activation of the license therefor. Herein, the “creator” represents the content creator/Licensor of DMC. Further, herein, the action may be payment of royalty/licensing fee to the content creator, out of proceeds from purchase of one or more of the DMC and the merchandise by the consumer, or some other form of recognition thereto without any limitations. The method further includes generating an access key for the DMC upon triggering of the action. The method further includes registering the generated access key for the DMC to the consumer. Herein, the access key is registered to Customer Token Wallet 178. Embodiments of the present disclosure provide the means to effectively and economically control and monetize the distribution and application of licensed DMC, particularly microcontent, to Merchandise on small scale, low volume runs. The ability to monitor, document and compensate the licensor incrementally, for their intellectual property as it is consumed, overcomes the limitations of the conventional licensing models which need front-load payout of royalties to cover the transaction costs of negotiating, drafting and enforcing licensing agreements.

Further embodiments of the method provide creating the tokenized merchandise item with associated DMC. Herein, the method includes receiving, from the consumer, a merchandise profile associated with a merchandise; assigning a merchandise token to the merchandise based on the corresponding merchandise profile; authenticating the merchandise token to generate a merchandise registration code for the merchandise; registering the generated merchandise registration code for the merchandise to the consumer; and anchoring the access key associated with the DMC to the merchandise registration code associated with the merchandise for the consumer. According to the present embodiments, since the merchandise rights for DMC are owned on a discrete basis, the consumer have the option of reassigning the licensed DMC to new or different items of merchandise at their discretion (consumer-driven) or trading it to another party to do the same. This significantly increases the value and utility of the DMC license and merchandise for the consumer.

Further embodiments of the method provide the consumer with option of selective assignment of the DMC to the item of merchandise. Herein, the method includes registering multiple access keys for corresponding multiple DMCs to the consumer; and allowing the consumer to selectively assign one or more of the multiple access keys to the merchandise registration code associated with the merchandise therefor. The technique described herein provides consumer access to DMC in such a way as to create a direct, elective, ongoing, channel between influencers, streamers or content creators and their followers, where regular content can be delivered on and by means of the Merchandise, creating what amounts to a Merchandise Media Channel upon which all manner of evolving content can flow. These “Jukebox DMC” licenses may not provide for the right to create consumer-curated Merchandise but may be deployed to any of the compatible items of Merchandise registered in the consumer's account.

Further embodiments of the method provide creating the tokenized merchandise item with associated DMC. Herein, the method includes recognizing the merchandise profile associated with the merchandise; retrieving the access key for the DMC anchored with the merchandise registration code associated with the merchandise having the recognized merchandise profile; and rendering the DMC in response to the retrieval of the access key thereof. Furthermore, the DMC can be periodically updated. Herein, rendering the updated DMC is based on the retrieval of the access key thereof. According to one embodiment of the present disclosure, the consumer may subscribe to a Merchandise Media Channel comprised of periodically updated Jukebox DMC. Jukebox DMC provided through the channel may be updated automatically on a daily, weekly or monthly basis, or may be updated on request by the consumer or in a manner that is linked to a payment cycle. Jukebox DMC may be provided through the Merchandise Media Channel for a fee or may be provided free-of-charge

Further embodiments of the method provide social sharing of DMC controlled by the consumer. Herein, the method includes allowing the consumer to select a subset of the DMC having the access key registered therewith; allowing the consumer to generate a guest access key for the selected subset of the DMC; and rendering the selected subset of the DMC in response to retrieval of the guest access key. Herein, rendering of the selected subset of the DMC is controlled by one or more of physical proximity of a deployment device of the consumer, social network permissions and time limit on rendering of the selected subset of the DMC. That is, access may also be granted through these same protocols to allow for private and selective viewing by others of what a given piece of merchandise is set to. This would mean that the “guest” would either be allowed to view: a) what the item is set to at that moment; or b) any media in the album associated with that item of merchandise; or c) a selected subset (like PG material or, on the other side the spectrum, more explicit content). Other embodiments may involve sharing mechanisms not detailed in the present disclosure.

Further embodiments of the method allow the content creator to provide limited content licenses. Herein, the method includes allowing the creator to set a limited number of the licenses for the DMC. Also, present embodiments enable the consumer to untether the DMC from the item of merchandise. Herein, the method includes remove the anchoring of the access key associated with the DMC to the merchandise registration code associated with the merchandise. Also, present embodiments enable the consumer to retether the DMC to another item of merch. Herein, the method includes allowing the consumer to transfer the access key associated with the DMC, as removed from the anchoring to the merchandise registration code associated with the merchandise, to be anchored to another merchandise registration code associated with another merchandise. Herein, the limited-edition status of the merchandise is governed by means of the tokenized media license, not the item of merchandise itself. In this manner, the collectible quality inures inherently to the item of merchandise when the DMC license is assigned to that item.

Further embodiments of the method allow for assigning an album of DMCs to the item of merch and creating a playlist thereof. Herein, the method includes anchoring multiple access keys associated with corresponding DMCs to the merchandise registration code associated with the merchandise for the consumer; and queuing the DMCs, as associated with the multiple access keys, in a desired order to be rendered in response to the retrieval of the multiple access keys thereof. That is, the present disclosure provides a method for rendering DMC upon the consumer's selection of Merchandise, in the fashion of a playlist. In this embodiment, the consumer indicates which of their available DMCs to pair with which item of Merchandise (utilizing Merchandise/DMC Pairing Engine 166) currently residing in their account. This creates the selected DMC/Merchandise pairing and registers the new pairing in the consumer's account.

Further embodiments of the method provide that the rendering of the DMC is in the form of one or more of Augment Reality (AR) rendering on the merchandise, and audio or video rendering on or off the merchandise. In one example, the rendering of the DMC is in the form of dynamic alteration of visual countenance of the merchandise through digital overlays, such that the rendering dynamically alters and regulate the visual countenance of the merchandise. That is, the consumer may match the Jukebox DMC or other DMC with the image on the selected Merchandise for a seamless video experience, or may select a Jukebox DMC or other DMC that will render by way of a transition from the Merchandise graphic to the video content of the DMC, in a fashion similar to the transmission between scenes in a video or film.

As described in detail below with reference to Methods 200a and 200c, of FIG. 2A and FIG. 2C, according to one embodiment of the present disclosure, DPT 124 is communicated to Distribution Server 150 to verify purchase/acquisition and to authenticate the DMC license. Merchandise Profile 122 is communicated to Distribution Server 150 to identify the product characteristics of Merchandise 110 against the specifications for that item resident in Merchandise License Database 171. System 100 then registers both Merchandise 110 and the DMC license to the consumer, activates the DMC license, and places the DMC license in Customer Token Wallet 178. Further, Processor 160 reports license activation to DMC/Access Cloud Server 180 for Methods 200a-200g, and for Methods 200a, 200b, 200e, 200g (and conditionally for Methods 200i and 200j) triggers royalty payments to DMC/Access Cloud Server 180. In one or more embodiments of the present disclosure, the tokenized DMC that is generated by Methods 200a-j of FIGS. 2A-2J as described below, is treated as a “free agent,” and can be paired with or applied to any compatible item of Merchandise 110.

As described in detail below with reference to Methods 200b, 200d and 200h of FIG. 2B, FIG. 2D and FIG. 2H, respectively, according to one embodiment of the present disclosure the same procedure applies as above, with the exception that Methods 200b, 200d and 200h portray Methods utilizing Chip Functionality 140 which incorporates DTM 144_{M} and Merchandise Token 142, enabling the consumer to authenticate and register ownership of the license for Merchandise 110 in Server Memory 170. For Methods 200b and 200d, concurrent with Merchandise 110's authentication, registration and integration with System 100, the associated DMC (as represented by DPT 124) is also authenticated and registered, at which point license activation is reported and/or a royalty payment to the DMC provider is triggered. The Merchandise license will only present authentication protections if Merchandise 110 has chip functionality.

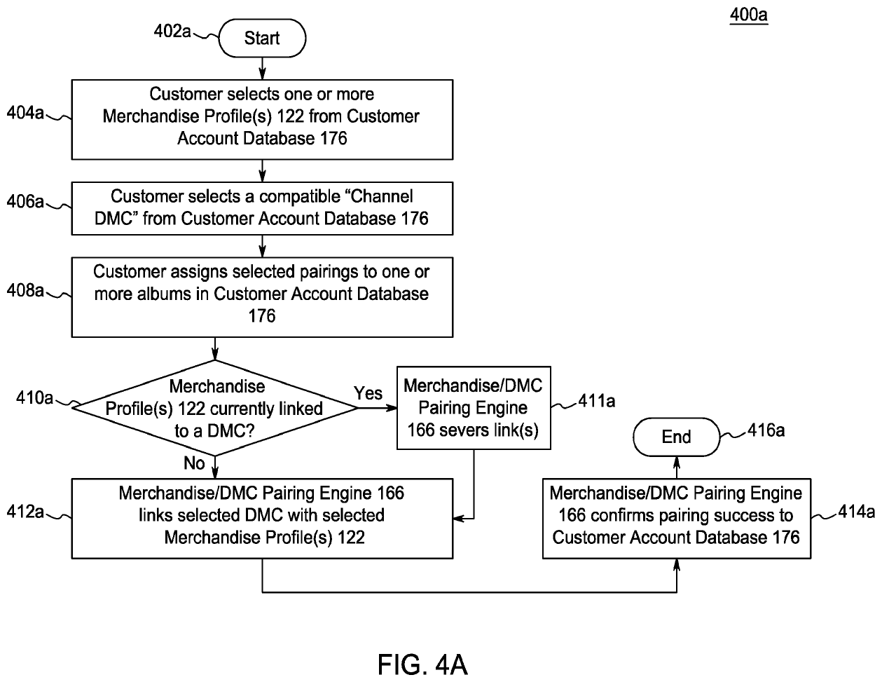

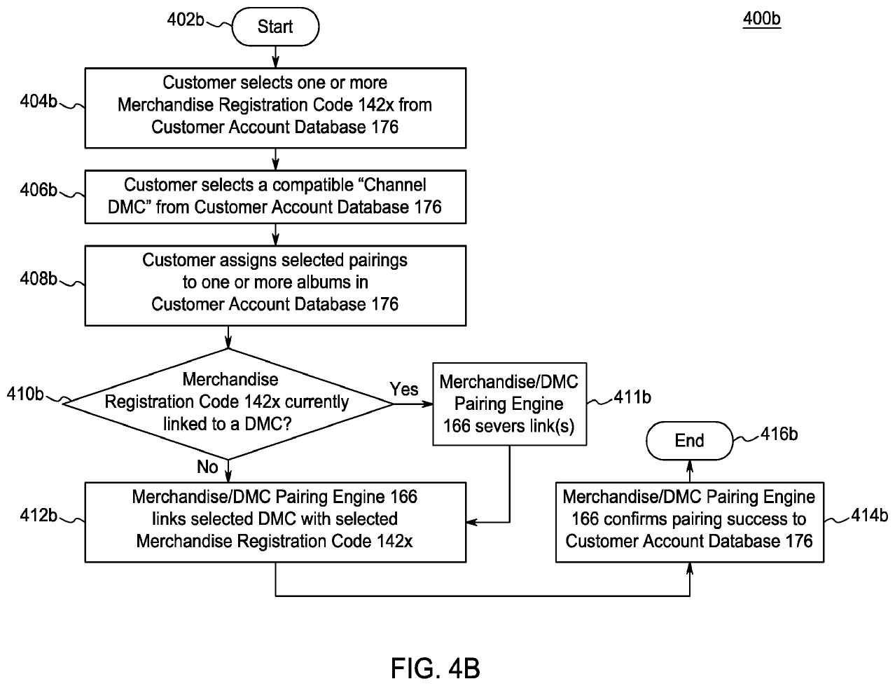

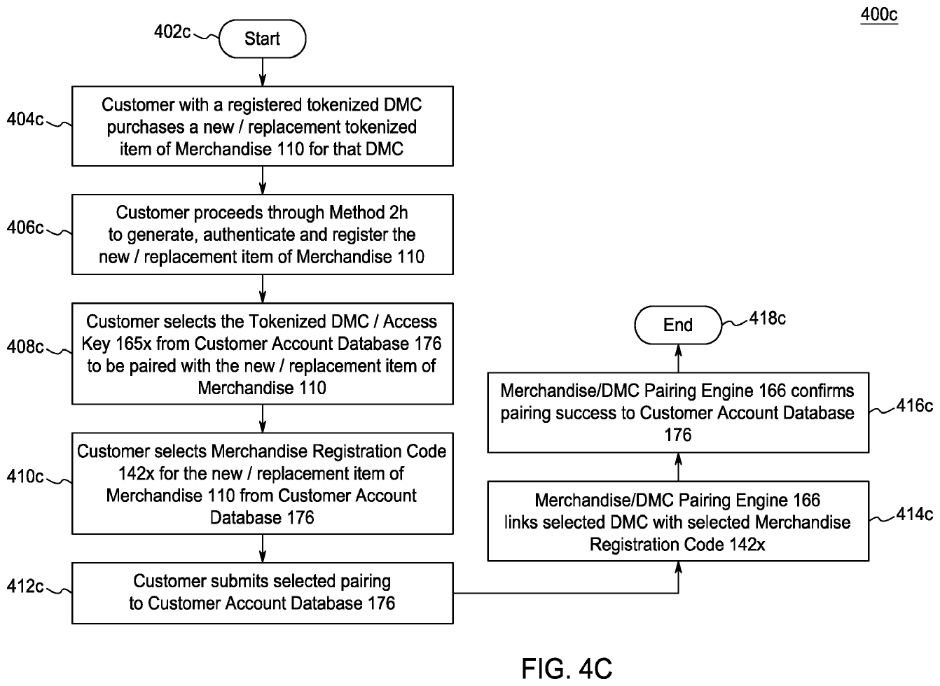

As described in detail below with reference to Methods 200e, 200f and 200j of FIG. 2E, FIG. 2F and FIG. 2J, respectively, according to one embodiment of the present disclosure the consumer may purchase or acquire a DMC or an Access Token to specified DMC directly from DMC/Access License Database 172, independent of Merchandise. In one embodiment, once the DMC is so acquired, Distribution Server 150 registers it, activates the DMC license, and places it in Customer Token Wallet 178. Method 200g follows the same procedure, but the DMC purchase/acquisition is made from Collectible DMC/Access License Database 173. In one embodiment of the present disclosure, the DPT 124 which is attached to an item of Merchandise 110 provides a mechanism for the consumer to activate, tokenize, take ownership, register, and store in Customer Token Wallet 178 the DMC license associated with an item of Merchandise 110. Due to the evolving codification feature that is intrinsic to the Data Authentication Technique utilized by System 100, in the event of loss of Merchandise 110 due to theft, flood damage, fire, etc., or merely a desire for change, one embodiment of the present disclosure allows the consumer to disconnect the DMC license from its currently assigned item of Merchandise 110, and reassign it to a different AR-enabled item. This ability to disconnect and reassign the DMC license is detailed in FIG. 4C and is accomplished by first, updating the DMC license's Registration Code (effectively nullifying its prior assignment), and second, assigning the new Registration Code to a different item of Merchandise 110 at the consumer's discretion. This is accomplished utilizing DAT Module 162 to update the DMC Registration Code, and Merchandise/DMC Pairing Engine 166 to effect the reassignment. In this embodiment, ownership of the DMC not only includes owning the merchandising rights, it also includes rights of consumption to that media content (singular or streaming), via the merchandise, along with the associated rights to the graphical triggers that make AR viewing possible.

As described in detail below with reference to Method 200g of FIG. 2G, according to one embodiment of the present disclosure the consumer may purchase or acquire a limited-edition (collectible) DMC license (for a specific item of video memorabilia) which includes as an integral component of the license a fixed number of tokenized AR sublicenses with rights to create consumer-curated AR-enabled merchandise. These sublicenses maintain their limited-edition collectible status by association with the parent collectible DMC license.

For example, if the parent license has the designation of #1 out of a limited edition of 1000 (for that collectible DMC), each of its five sublicenses inherit the designation of #1[n] out of 1000 AR-enabling sublicenses for that DMC (where ‘n’ is the number of sublicenses issued for the parent license, in this example, 5), for a restricted total of 1000 parent licenses and 5000 AR sublicenses. This embodiment references limited-edition merchandising rights, but also applies to non-limited-edition merchandising rights.

As described in detail below, again, with reference to Method 200g of FIG. 2G, according to one embodiment of the present disclosure the Cooperative Manufacturing functionality is enabled when the consumer registers their DMC license. As applied to collectible DMC licenses generated in Method 200g, each registered, tokenized AR sublicense is considered owned by the consumer, with an intrinsic, enduring value that is established by the terms of the parent license. The value is an inextricable property (a right) of the sublicense itself and travels with the sublicense. When the consumer combines one of their registered AR sublicenses with an object registered in the Merchandise Licensed Database 171, to create an item of Merchandise 110, the sublicense itself contributes unique value to the finished item of Merchandise 110 through Cooperative Manufacturing. The Cooperative Manufacturing functionality described in Method 200g applies equally to collectible and non-collectible, tokenized DMC licenses as paired with digital-media-enhanced merchandise. This embodiment includes the capacity for DMC licenses to be applied across merchandise categories at the consumer's discretion or curation. This embodiment references limited-edition merchandising rights, but also applies to non-limited-edition merchandising rights.

As described in detail below with reference to Methods 200a, 200b, 200e, 200g and 200j of FIGS. 2A, 2B, 2E, 2G and 2J, respectively, according to one embodiment of the present disclosure the incremental licensing of DMCs is provided such that the license activates and triggers a royalty payment post-purchase. Furthermore, combining the use of tokenized DMC licenses with the DAT authentication controls described in the Methods of this disclosure may provide heightened security and privacy protections due to the authentication on a distributed, fractionalized basis, without the need for ledgers or a public keys (both of which are liable to disclosure of private information about the transaction history of the authenticated merchandise and/or the identity of the parties to the transaction, and present the possibility of future vulnerabilities with regard to Quantum Computing attacks).

As described in detail below with reference to Methods 300a through 300e of FIG. 3A through FIG. 3E, according to one embodiment of the present disclosure the rendering of the DMC is enabled. For this purpose, the consumer brings Deployment Device 190 into range of anchored Merchandise 110. Processor 160 recognizes Merchandise 110 (and authenticates it in the case of Method 300b) and verifies authenticity of the DMC/Access Key license. If Access Key is authenticated, Processor 160 directs DMC/Access Cloud Server 180 to stream the associated DMC; or if a discrete DMC token, deploys DMC via Deployment Device 190 upon Merchandise 110. Methods 300c and 300d of FIG. 3C and FIG. 3D, respectively, involve the additional step wherein the consumer selects the desired DMC or Access Key from Customer Token Wallet 178 prior to bringing Deployment Device 190 into range. Such evolving codification may also prevent the fraudulent use of counterfeit items of merchandise to trigger free renderings. In the absence of evolving codification, costly, pirated renderings could be generated on an unlimited basis by means of skimming and applying the static GUI 120 and DMC, and/or Merchandise First Code(s) present on the original item of Merchandise 110, to huge runs of counterfeit items. In the absence of evolving DMC Registration Code, GUI 192 (a readily downloadable app, a webpage or other modality) could then be used to direct Processor 160 to render the pirated AR experiences upon the counterfeit items by exploiting the skimmed, static DMC Registration Code, which is not possible with the present evolving DMC Registration Code.

Further, as described in detail below with reference to Methods 300a through 300e of FIGS. 3A through 3E, according to one embodiment of the present disclosure the Registration Codes for the DMC and/or Merchandise tokens go through authentication and are updated by DAT Module 162 every time the Method is launched. In another embodiment, the authentication may be set to endure for a fixed period of time, such as 10 minutes. In yet another embodiment, the authentication is carried out only upon transference of DMC to another item of merchandise or upon transfer of DMC/Merchandise tokens to another party. Longer intervals of time in between allow future iterations of Methods 300a through 300e to bypass the authentication and updating steps if launched any time during the still-active window of the previous authentication. If launched, after the previous authentication expires, the authentication and updating steps of Methods 300a through 300e would be employed. In another embodiment, authentication of the Registration Code(s) does not persist beyond completion of the Method in which the authentication occurred and so cannot be used in lieu of the authentication steps in future iterations of Methods 300a through 300e.

As described in detail below with reference to Methods 400a through 400c of FIG. 4A through FIG. 4C, according to one embodiment of the present disclosure DMC licenses may be purchased or acquired for digital rendering upon compatible Merchandise 110 that serve as a media distribution channel for Merchandise Media Channel DMC or Jukebox DMC. Methods 400a and 400b describes the manner in which registered Jukebox DMCs and Merchandise 110 residing in Customer Account Database 176, are organized, authenticated, paired, and re-paired. Further, Method 400c enable the consumer to replace a lost, damaged or retired tokenized item of Merchandise 110 with new or different one, and reassign the DMC that was paired with the original tokenized item to the new tokenized item. The registered Jukebox DMCs and Merchandise 110 are organized in such a fashion that the consumer may select the item(s) of Merchandise 110 on which to render the selected DMC when Deployment Device 190 is brought within range. The consumer may match the DMC with the image on the GUI 120 of the selected Merchandise 110 for a seamless video experience, or may select a Media Merchandise Channel or Jukebox DMC that will render by way of a transition from the GUI 120 image to the content of the DMC in a fashion similar to the transmission between slides of a PowerPoint presentation. These DMC licenses may not provide for the right to create consumer-curated Merchandise, but may be deployed to any of the compatible items of Merchandise 110 registered in the consumer's account. In another embodiment of the present disclosure, the registered DMC license grants the consumer the right to not only create consumer-curated AR-enabled Merchandise, but to render the DMC on compatible Merchandise as well (compatibility determined by the DMC owner), in such a manner that the DMC to be rendered does not have to match the image on any one item of Merchandise 110. In such a case, the image may serve as a switch to launch the rendering rather than being incorporated in the AR experience to give the impression of the image coming to life.

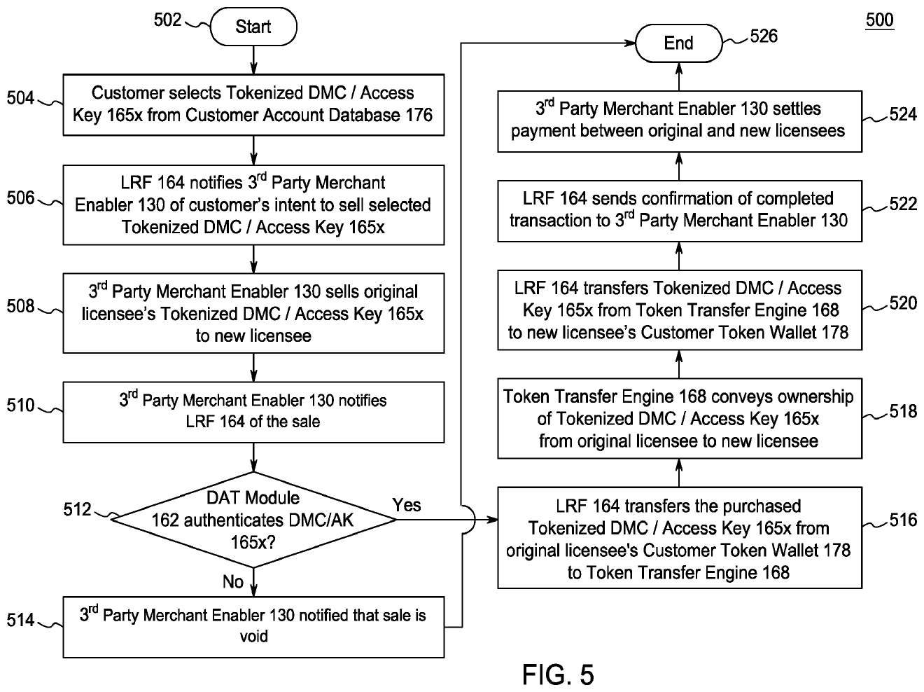

As described in detail below with reference to Method 500 of FIG. 5, according to one embodiment of the present disclosure licensed DMCs (collectible or otherwise) can be transferred between consumers in a secure (authenticated) and discrete fashion, allowing for a secondary market for tokenized DMC licenses. Herein, a process is described whereby each collectible, tokenized AR sublicense may be traded with other registered AR licenses or sublicenses offered by the same or different digital media content providers. The right to trade a particular license or sublicense would be at the discretion of the licensor, and if offered would be granted at the time of acquisition/registration, or by arrangement at a later date, according to the terms of the license or parent license. By way of example, if Turner Classic Movies (now Warner Media), were a participating licensor of the present disclosure, they may permit the exchange of “Gone with the Wind” clips for other DMC classic properties that they own such as “Casablanca” or “The Sound of Music.” Other DMC licensors may permit the cross-exchange of collectible or non-collectible DMC licenses with other participating licensors to incentivize the initial DMC/Merchandise 110 purchase and popularize/create further demand through the secondary license exchange market. This embodiment includes the trading of consumption-oriented DMC (as opposed to DMC with accompanying merchandising rights).

FIG. 2A depicts Method 200a for generation, authentication and registration of the royalty-based DMC from Merchandise 110, without IoT chip technology, for each consumer, according to an embodiment of the present disclosure. Method 200a, which does not use Chip Functionality 140, starts at step 202a and proceeds to step 204a, where the consumer purchases or acquires Merchandise 110 and downloads GUI 192 into Deployment Device 190 of FIG. 1. At step 206a, the consumer brings Deployment Device 190 into range of Merchandise 110 of FIG. 1. At step 208a, GUI 192 recognizes Merchandise Profile 122 by accessing the associated merchandise specifications residing in Merchandise License Database 171 of FIG. 1. If not recognized, then Method 200a ends at step 226a. If recognized, Method 200a proceeds to step 210a, where GUI 192 uploads DPT 124 into DAT Module 162 of FIG. 1. Proceeding to step 212a, DAT Module 162 verifies the authenticity of DPT 124 of FIG. 1. If not authenticated then Method 200a ends at step 226a. At step 214a, DAT Module 162 transforms DPT 124 into DMC Registration Code 124x. At step 216a, LRF 164 indexes DMC Registration Code 124x in Customer Account Database 176, activates associated DMC license, and reports license activation to DMC/Access Cloud Server 180. At step 218a, LRF 164 transfers DMC Registration Code 124x to Token Fusing Module 165. At step 220a, Token Fusing Module 165 retrieves DMC/Access Key 182x (either the DMC itself or an Access Key to the specified DMC) associated with DMC Registration Code 124x from Royalty Collection 182, and triggers royalty payment to DMC provider, likely content creator (not shown). At step 222a, Token Fusing Module 165 fuses DMC Registration Code 124x with DMC/Access Key 182x, creating Tokenized DMC/Access Key 165x. At step 224a, Token Fusing Module 165 sends Tokenized DMC/Access Key 165x to Customer Token Wallet 178 of FIG. 1. Method 200a ends at step 226a.

FIG. 2B depicts Method 200b for generation, authentication and registration of the royalty-based DMC from Merchandise 110, with IoT chip technology, for each consumer, according to an embodiment of the present disclosure. Method 200b of FIG. 2B utilizes Chip Functionality 140 to validate the authenticity of Merchandise 110, follows the same procedure as Method 200a, from step 202b through step 210b. At step 212b, Merchandise Token 142 (the Fist Code of which remains behind on Chip Functionality 140 as a static identification code) is sent to DAT Module 162 for authentication via DTMs 144_{M/D/S}. Proceeding to step 214b, DAT Module 162 authenticates DPT 124 and Merchandise Token 142 of FIG. 1. If not authenticated, Method 200b ends at step 226b. At step 216b, DAT Module 162 transforms DPT 124 into DMC Registration Code 124x, and Merchandise Token 142 to Merchandise Registration Code 142x. At step 218b, LRF 164 indexes Registration Codes 124x and 142x in Customer Account Database 176, activates the associated DMC license, and reports license activation to DMC/Access Cloud Server 180. At step 220b, LRF 164 transfers Registration Codes 124x and 142x to Token Fusing Module 165. At step 222b, Token Fusing Module 165 retrieves from Royalty Collection 182 the DMC/Access Key 182x (either the DMC itself or an Access Key to the specified DMC) associated with DMC Registration Code 124x, and triggers royalty payment to DMC provider (not shown in FIG. 1). Proceeding to step 224b, Token Fusing Module 165 fuses DMC Registration Code 124x with DMC/Access Key 182x, creating Tokenized DMC/Access Key 165x. At step 226b, Token Fusing Module 165 sends Tokenized DMC/Access Key 165x and Merchandise Registration Code 142x to Customer Token Wallet 178. Method 200b ends at step 228b

FIG. 2C depicts Method 200c for generation, authentication and registration of a Non-Royalty-Based DMC, without IoT chips, from Merchandise 110 for each consumer, according to an embodiment of the present disclosure. Method 200c, which does not use Chip Functionality 140, follows the same procedure as Method 200a, from step 202c through step 218c. At 220c, Token Fusing Module 165 retrieves DMC/Access Key 184x (either the DMC itself or an Access Key to the specified DMC) associated with DMC Registration Code 124x from Non-Royalty Collection 184. At step 222c, Token Fusing Module 165 fuses DMC Registration Code 124x with DMC/Access Key 184x, creating Tokenized DMC/Access Key 165x. At step 224c, Token Fusing Module 165 sends Tokenized DMC/Access Key 165x to Customer Token Wallet 178. Method 200c ends at step 226c.

FIG. 2D depicts Method 200d for generation, authentication and registration of a Non-Royalty-Based DMC, with IoT chips, from Merchandise 110 for each consumer, according to an embodiment of the present disclosure. Method 200d, which utilizes Chip Functionality 140, follows the same procedure as Method 200b, from step 202d through step 220d. At step 222d, Token Fusing Module 165 retrieves DMC/Access Key 184x (either the DMC itself or an Access Key to the specified DMC) associated with DMC Registration Code 124x from Non-Royalty Collection 184. Proceeding to step 224d, Token Fusing Module 165 fuses DMC Registration Code 124x with DMC/Access Key 184x, creating Tokenized DMC/Access Key 165x. At step 226d, Token Fusing Module 165 sends Tokenized DMC/Access Key 165x and Merchandise Registration Code 142x to Customer Token Wallet 178. Method 200d ends at step 228d.

Alternatively, if the DMC license is to be acquired from Digital Media Content providers independent of Merchandise 110, Method 200e of FIG. 2E is used. FIG. 2E depicts Method 200e for generation and registration of royalty-based DMC from digital media content providers, according to an embodiment of the present disclosure. Method 200e starts at step 202e and proceeds to step 204e where the consumer purchases or acquires the DMC or Access Key license (as represented by DMC/Access License 172x) from DMC/Access License Database 172 of FIG. 1. At step 206e, DMC/Access License Database 172 triggers Unissued Token Database 174 to issue Token 174x to DAT Module 162 of FIG. 1. At step 208e, DAT Module 162 transforms Token 174x into DMC/Access Registration Code 172x. Proceeding to step 210e, LRF 164 indexes DMC/Access Registration Code 172x in Customer Account Database 176 and activates the associated DMC or Access Key license. At step 212e, LRF 164 reports license activation to DMC/Access Cloud Server 180. At step 214e, LRF 164 transfers DMC/Access Registration Code 172x to Token Fusing Module 165. Next, at step 216e, Token Fusing Module 165 retrieves DMC/Access Key 182x (either the DMC itself or an Access Key to the specified DMC) associated with DMC/Access Registration Code 172x from Royalty Collection 182, and triggers royalty payment to DMC provider (not shown in FIG. 1). A step 218e, Token Fusing Module 165 fuses DMC/Access Registration Code 172x with DMC/Access Key 182x, creating Tokenized DMC/Access Key 165x. Finally, at step 220e, Token Fusing Module 165 sends Tokenized DMC/Access Key 165x to Customer Token Wallet 178, and Method 200e ends at step 222e.

FIG. 2F depicts Method 200f for generation and registration of non-royalty DMC from Digital Media Content providers, independent of Merchandise 110. Method 200f follows the same procedure as Method 200e, from step 202f through step 214f. At step 216f, Token Fusing Module 165 retrieves DMC/Access Key 184x (either the DMC itself or an Access Key to the specified DMC) associated with DMC/Access Registration Code 172x from Non-Royalty Collection 184. At step 218f, Token Fusing Module 165 fuses DMC/Access Registration Code 172x with DMC/Access Key 184x, creating Tokenized DMC/Access Key 165x. At step 220f, Token Fusing Module 165 sends Tokenized DMC/Access Key 165x to Customer Token Wallet 178, and Method 200f ends at step 222f.

FIG. 2G depicts Method 200g for generation and registration of a royalty-based, collectible DMC from digital media content providers, according to an embodiment of the present disclosure. Collectibles may include the DMC itself as a limited-edition collectible item (akin to a limited-edition lithograph), and/or collectible AR-merchandising licenses associated with that collectible DMC, which give the holder rights of consumer-curated creation of Merchandise formed from assignment of that DMC to merchandise. The collectible AR-merchandising licenses may be individual sublicenses, with rights to assign the collectible DMC to Merchandise 110 for AR rendering. These collectible DMCs are indexed in the Collectible DMC/Access License Database 173 which includes information regarding all collectibles available for purchase and distribution in System 100. In one embodiment, the tokenized DMCs reside in Customer Token Wallet 178. In another they reside in Deployment Device (DD) Database 194 of Deployment Device 190. Method 200g starts at step 202g and proceeds to step 204g where the consumer purchases or acquires a DMC/Access Collectible License 173cx (which includes ‘n’ number of AR DMC/Access License(s) 173ax where ‘n’ is a variable quantity that is fixed by the terms of the license) from Collectible DMC/Access License Database 173 of FIG. 1. At step 206g, Collectible DMC/Access License Database 173 triggers Unissued Token Database 174 to issue one plus ‘n’ Token(s) 174x. to DAT Module 162 of FIG. 1. At step 208g, DAT Module 162 transforms Token(s) 174x into one Collectible DMC/Access Registration Code 173cx plus ‘n’ AR DMC/Access Registration Code(s) 173ax. At step 210g, LRF 164 indexes DMC/Access Registration Code(s) 173cx and 173ax in Customer Account Database 176 of FIG. 1 and activates associated DMC or Access licenses. Proceeding to step 212g, LRF 164 reports license activation to DMC/Access Cloud Server 180, after which at step 214g, LRF 164 transfers DMC/Access Registration Codes 173cx and 173ax to Token Fusing Module 165. At step 216g, Token Fusing Module 165 retrieves DMC/Access Key 182x (either the DMC itself or an Access Key to the specified DMC) associated with DMC/Access Registration Code 173cx from Royalty Collection 182, and triggers royalty payment to DMC provider (not shown in FIG. 1). At step 218g, Token Fusing Module 165 fuses DMC/Access Registration Code(s) 173cx and 173ax with DMC/Access Key 182x, creating one Tokenized Collectible DMC 165cx and ‘n’ Tokenized AR DMCs 165ax respectively. At step 220g, Token Fusing Module 165 sends Tokenized Collectible DMC 165cx and ‘n’ Tokenized AR DMC(s) 165ax to Customer Token Wallet 178, and Method 200g ends at step 222g.

FIG. 2H depicts Method 200h for generation, authentication and registration of tokenized Merchandise, without an associated DMC. In one embodiment, the generation of tokenized Merchandise, independent of a DMC permits the consumer to purchase or acquire and register a new item of Merchandise 110 to replace one that has been lost, damaged or otherwise “retired” by the consumer. Method 200h starts at step 202h and proceeds to step 204h where the consumer purchases or acquires tokenized Merchandise 110, followed by step 206h where the consumer brings Deployment Device 190 into range of newly acquired tokenized Merchandise 110. At step 208h, GUI 192 recognizes Merchandise Profile 122 by accessing the associated merchandise specifications residing in Merchandise License Database 171 of FIG. 1. If not recognized, then Method 200h ends at 222h. At step 210h, if Merchandise Profile 122 is recognized, Merchandise Token 142 is sent to DAT Module 162 for authentication via DTMs 144_{M}, 144_{D}, and 144ₛ. At step 212h, DAT Module 162 authenticates Merchandise Token 142 of FIG. 1. If not authenticated, then Method 200h ends at step 222h. At step 214h, if Merchandise Token 142 is authenticated, DAT Module 162 transforms Merchandise Token 142 into Merchandise Registration Code 142x. At step 216h, LRF 164 indexes Merchandise Registration Code 142x in Customer Account Database 176, after which at step 218h, LRF 164 transfers Merchandise Registration Code 142x to Token Fusing Module 165. At step 220h, Token Fusing Module 165 sends Merchandise Registration Code 142x to Customer Token Wallet 178, and Method 200h ends at step 222h.

FIG. 2I depicts Method 200i for generation and registration of pre-tokenized DMC from Merchandise 110, according to an embodiment of the present disclosure. Method 200i, which does not indicate the use of IoT chip technology, or whether the DMCs are royalty-based or non-royalty-based, but in other embodiments may, starts at step 202i and proceeds to step 204i, where the consumer purchases or acquires Merchandise 110 and downloads GUI 192 into Deployment Device 190 of FIG. 1. At step 206i, the consumer uses Deployment Device 190 to upload Merchandise Token 142 and Merchandise Profile 122 from GUI 120 to DAT Module 162 and LRF 164 respectively. At step 208i, DAT Module 162 authenticates Merchandise Token 142. If not authenticated, Method 200i ends at step 224i. If Merchandise Token 142 is authenticated, Method 200i proceeds to step 210i, where LRF 164 sends download instructions to DMC/Access Cloud Server 180. At step 212i, DMC/Access Cloud Server 180 then downloads Tokenized DMC/Access Key 165x (either the DMC itself or an Access Key to the specified DMC) to DAT Module 162. At step 214i, Tokenized DMC/Access Key 165x is updated using DAT Module 162. At step 216i, LRF 164 indexes Tokenized DMC/Access Key 165x in Customer Account Database 176. And at step 218i, the DMC/Access License 172x is examined to determine if any royalty is due and owing. If so, then at step 220i, LRF 164 triggers a royalty payment to the DMC provider (not shown in FIG. 1). Once paid, (or if a royalty payment isn't indeed due), Method 200i proceeds to 222i, where LRF 164 sends Tokenized DMC/Access Key 165x to Customer Token Wallet 178, of FIG. 1, and Method 200i ends at step 224i. In one embodiment, Merchandise Token 142 is embedded in GUI 120 as DPT 124, while in another it is on Chip Functionality 140. In yet another embodiment, DAT Module 162 resides in DMC/Access Cloud Server 180.

In a specialized embodiment or the present disclosure, Merchandise 110 may be a poster or other advertisement where Tokenized DMC/Access Key 165x is a licensed key that can be downloaded more than once by multiple parties so as to receive ongoing streaming DMCs on that Merchandise Media Channel (with the number of times regulated by DMC/Access Cloud Server 180). In one embodiment these downloads may be triggered by Merchandise 122 or other GUI residing on Merchandise 110. In another embodiment, DPT 124 may be used instead of GUI 120 and DPT 124 is verified as unique using DAT Module 162 before being authorized to send download instructions to DMC/Access Cloud Server 180 to retrieve the associated Tokenized DMC/Access Key 165x.

FIG. 2J depicts Method 200j for generation and registration of pre-tokenized DMC from digital media content providers. Method 200j, which does not indicate the use IoT chip technology, but in other embodiments may, starts at step 202j and proceeds to step 204j, where the consumer acquires DMC/Access License 172x from DMC/Access License Database 172. At step 206j, DMC/Access License Database 172 triggers LRF 164 to send download instructions to DMC/Access Cloud Server 180. Method 200j then follows the same procedure of Method 200i from 212i through 222i, and Method 200j ends at step 220j.

FIG. 3A depicts Method 300a for-distributing authenticated digital media content (DMC) for AR rendering on anchored Merchandise, with IoT chips, according to an embodiment of the present disclosure. Anchored Merchandise in this usage means Merchandise which is fixed to the specific image of Merchandise Profile 122 at the point of manufacture with a singular DMC associated with Merchandise 110, which is specified in Merchandise Database 171. Method 300a starts at step 302a and proceeds to step 304a, where the consumer brings Deployment Device 190 in range of anchored Merchandise 110 of FIG. 1. At step 306a, GUI 192 accesses the merchandise specifications residing in Merchandise License Database 171 and recognizes Merchandise Profile 122 which may be embedded within GUI 120. If not recognized, then Method 300a ends at 322a. At step 308a, GUI 192 uploads Merchandise Profile 122 to LRF 164. At step 310a, LRF 164 accesses Customer Account Database 176 and identifies the Tokenized DMC/Access Key 165x anchored to Merchandise Profile 122. At step 312a, LRF 164 retrieves the identified Tokenized DMC/Access Key 165x from Customer Token Wallet 178 and sends it to DAT Module 162. Proceeding to step 314a, DAT Module 162 authenticates and updates Tokenized DMC/Access Key 165x. If not authenticated, then no DMC shall be provided for rendering, and Method 300a is ended at step 322a. At step 316a, if Tokenized DMC/Access Key 165x has been authenticated and updated, LRF determines if DMC/Access Key 165x is an Access Key or a DMC. If an Access Key, at step 317a LRF 164 initiates Method 300e (as detailed below) to stream the associated DMC to GUI 192 directly from DMC/Access Cloud Server 180, which ends Method 300a at step 322a. If DMC/Access Key 165x is a DMC, at step 318a, LRF sends Tokenized DMC/Access Key 165x and Merchandise Profile 122 to AR Deployment Engine 167. Proceeding to step 320a, AR Deployment Engine 167 distributes Tokenized DMC/Access Key 165x to GUI 192 for rendering on Merchandise 110, and Method 300a ends at step 322a.

FIG. 3B depicts Method 300b for distributing authenticated DMC for augmented reality rendering on anchored Merchandise, with IoT chips, according to an embodiment of the present disclosure. According to one embodiment, depicted in Method 300b in FIG. 3B, Merchandise 110 and Deployment Device 190 are part of an IoT network and DTM 140_{M} and DTM 140_{D} are small range communication techniques, such that when Merchandise 110 is brought within range of Deployment Device 190, Deployment Device 190 accesses Merchandise Token 142 (stored in Chip Functionality 140) through DTM 140_{M} and DTM 140_{D} and transmits Merchandise Token 142 to DAT Module 162 of FIG. 1 through DTM 140s for authentication. Steps 302b308b as depicted in Method 300b are identical to steps 302a-308a of Method 300a. At step 310b, Merchandise Token 142 is sent to DAT Module 162 for authentication via DTMs 144_{M}, 144_{D}, and 144_{S}. At step 312b, Merchandise Token 142 is authenticated using DAT Module 162 of FIG. 1. If not authenticated, then Method 300b ends at step 326b. At step 314b, if Merchandise Token 142 is authenticated, LRF 164 accesses Customer Account Database 176 and identifies the Tokenized DMC/Access Key 165x anchored to Merchandise Token 142. At step 316b, LRF 164 retrieves the identified Tokenized DMC/Access Key 165x from Customer Token Wallet 178 and sends it to DAT Module 162 of FIG. 1. At step 318b, Tokenized DMC/Access Key 165x is authenticated and updated using DAT Module 162. If not authenticated, then no DMC shall be provided for rendering, and Method 300b is ended at step 326b. If authenticated, then at step 320b, LRF determines if DMC/Access Key 165x is an Access Key or a DMC. If an Access Key, at step 321b, LRF 164 initiates Method 300e (as detailed below) to stream the associated DMC to GUI 192 directly from DMC/Access Cloud Server 180, which ends Method 300b at step 326b. At step 322b, if Tokenized DMC/Access Key 165x is not an Access Key, LRF sends updated Tokenized DMC/Access Key 165x and Merchandise Profile 122 to AR Deployment Engine 167 of FIG. 1. Finally, at step 324b, AR Deployment Engine 167 distributes Tokenized DMC/Access Key 165x to GUI 192 for rendering on Merchandise 110, and Method 300b ends at step 326b.

FIG. 3C depicts Method 300c for-distributing authenticated digital media content (DMC) for AR rendering on unanchored Merchandise, with IoT chips, according to an embodiment of the present disclosure. Unanchored Merchandise in this usage means Merchandise which is not fixed to the specific image of Merchandise Profile 122 at the time of manufacture with a singular DMC associated with Merchandise 110, as specified in Merchandise Database 171. Method 300c starts at step 302c and proceeds to step 304c, where, if not already preselected, the consumer selects Tokenized DMC/Access Key 165x to be rendered from Customer Account Database 176 of FIG. 1. At step 306c, the consumer brings Deployment Device 190 in range of unanchored Merchandise 110 of FIG. 1. At step 308c, GUI 192 accesses the merchandise specifications residing in Merchandise License Database 171 and recognizes Merchandise Profile 122, which may be embedded within GUI 120. If not recognized, then Method 300c ends at step 328c. At step 310c, if Merchandise Profile 122 is recognized, GUI 192 uploads Merchandise Profile 122 to LRF 164. At step 312c, LRF 164 accesses Customer Account Database 176 and identifies the Tokenized DMC/Access Key 165x selected to be paired to Merchandise Profile 122. At step 314c, LRF 164 retrieves the selected Tokenized DMC/Access Key 165x from Customer Token Wallet 178 and sends it to DAT Module 162 of FIG. 1. At step 316c, Tokenized DMC/Access Key 165x is authenticated and updated using DAT Module 162. If not authenticated, then no DMC shall be provided for rendering, and Method 300c is ended at step 328c. At step 318c, if Tokenized DMC/Access Key 165x is authenticated, LRF determines if DMC/Access Key 165x is an Access Key or a DMC. If an Access Key, at step 319c, LRF 164 initiates Method 300e (as detailed below) to stream the associated DMC to GUI 192 directly from DMC/Access Cloud Server 180, which ends Method 300c at step 328c.

At step 320c, if Tokenized DMC/Access Key 165x is not an Access Key, LRF sends updated Tokenized DMC/Access Key 165x and Merchandise Profile 122 to Merchandise/DMC Pairing Engine 166. Proceeding to step 322c, Merchandise/DMC Pairing Engine 166 links updated Tokenized DMC/Access Key 165x with Merchandise Profile 122. At step 324c, Merchandise/DMC Pairing Engine 166 sends the combined Tokenized DMC/Access Key 165x and Merchandise Profile 122 to AR Deployment Engine 167. Finally, at step 326c, AR Deployment Engine 167 distributes Tokenized DMC/Access Key 165x to GUI 192 for rendering on Merchandise 110, and Method 300c ends at step 328c.

FIG. 3D depicts Method 300d for distributing authenticated DMC for augmented reality rendering on unanchored Merchandise, with IoT chips, according to an embodiment of the present disclosure. As with Method 300b above, according to one embodiment depicted in Method 300d, Merchandise 110 and Deployment Device 190 are part of an IoT network. Steps 302d-310d as depicted in Method 300d are identical to steps 302c-310c of Method 300c. At step 312d, Merchandise Token 142 is sent to DAT Module 162 for authentication via DTMs 144M, 144D, and 144S. At step 314d, Merchandise Token 142 is authenticated and updated using DAT Module 162 of FIG. 1. If not authenticated, then Method 300d ends at step 330d. If authenticated, at step 316d, LRF 164 accesses Customer Account Database 176 and identifies Tokenized DMC/Access Key 165x selected to be paired to Merchandise Token 142. At step 318d, LRF 164 retrieves the selected Tokenized DMC/Access Key 165x from Customer Token Wallet 178 and sends it to DAT Module 162. Proceeding to step 320d, Tokenized DMC/Access Key 165x is authenticated and updated using DAT Module 162. If not authenticated, then Method 300d ends at step 330d. At step 322d, if Tokenized DMC/Access Key 165x is authenticated, LRF determines if DMC/Access Key 165x is an Access Key or a DMC. If an Access Key, at step 323d, LRF 164 initiates Method 300e (as detailed below) to stream the associated DMC to GUI 192 directly from DMC/Access Cloud Server 180, which ends Method 300d at step 330d. At step 324d, if Tokenized DMC/Access Key 165x is not an Access Key, LRF sends updated Tokenized DMC/Access Key 165x and Merchandise Profile 122 to Merchandise/DMC Pairing Engine 166. At step 326d, Merchandise/DMC Pairing Engine 166 links the updated Tokenized DMC/Access Key 165x with Merchandise Profile 122. Finally, at step 328d, AR Deployment Engine 167 distributes Tokenized DMC/Access Key 165x to GUI 192 for rendering on Merchandise 110 of FIG. 1, and Method 300c ends at step 330d.

FIG. 3E depicts Method 300e for streaming authenticated DMC for AR rendering directly from DMC/Access Cloud Server 180, according to an embodiment of the present disclosure. Method 300e starts at step 302e and proceeds to step 304e, where LRF sends streaming instructions from Tokenized DMC/Access Key 165x to DMC/Access Cloud Server 180. At step 306e, DMC/Access Cloud Server 180 streams the DMC associated with Tokenized DMC/Access Key 165x to GUI 192 for rendering on Merchandise 110, and Method 300e ends at step 308e. In one embodiment, DMC/Access Cloud Server 180 streams the DMC associated with Tokenized DMC/Access Key 165x directly to Deployment Device 190, bypassing the triggering mechanism of GUI 130 on Merchandise 110.

FIG. 4A depicts Method 400a for pairing/re-pairing Media Merchandise Channel or Jukebox DMCs with selected Merchandise 110. In one embodiment of the present disclosure, the DMC may be a subscription-based streaming or serially downloaded DMC. Method 400a starts at step 402a and proceeds to step 404a where the consumer selects one or more Merchandise Profile(s) 122 from Customer Account Database 176 of FIG. 1. At step 406a, the consumer selects a compatible Jukebox DMC from Customer Account Database 176 to pair with each of the selected Merchandise Profile(s) 122. At step 408a, the consumer assigns selected pairings to one or more albums in Customer Account Database 176. At step 410a, Merchandise/DMC Pairing Engine 166 of FIG. 1 determines if the selected Merchandise Profile 122 is currently linked to a DMC. If linked, Merchandise/DMC Paring Engine 166 severs the existing link at step 411a. Method 400a proceeds from step 410a directly to step 412a if Merchandise 110 is not linked or proceeds first through step 411a to sever the link if Merchandise 110 has a pre-existing link. At step 412a Merchandise/DMC Pairing Engine 166 links selected DMC with selected Merchandise Profile 122. Finally, at step 414a, Merchandise/DMC Pairing Engine 166 confirms pairing success to Customer Account Database 176 of FIG. 1, and Method 400a ends at step 416a.

FIG. 4B depicts Method 400b for pairing/re-pairing Media Merchandise Channel or Jukebox DMCs with selected, tokenized Merchandise 110. According to one embodiment which is depicted in Method 400b, the tokenization of Merchandise 110 identified by means of an NFC or similar technology, creates a unique individual identifier for the physical object. This permits the consumer or content provider to specify a unique pairing of DMC with that object alone, and so create an item of Merchandise with unique intrinsic value and/or capabilities not shared by other DMC/Merchandise pairings. Method 400b starts at step 402b and proceeds to step 404b where the consumer selects one or more Merchandise Registration Codes 142x from Customer Account Database 176 of FIG. 1. At step 406b, the consumer selects a compatible DMC from Customer Account Database 176 to pair with the selected Merchandise Registration Code(s) 142x. At step 408b, the consumer assigns selected pairings to one or more albums in Customer Account Database 176. At step 410b, Merchandise/DMC Pairing Engine 166 of FIG. 1 determines if the selected Merchandise Registration Code 142x is currently linked to a DMC. If linked, Merchandise/DMC Paring Engine 166 severs the existing link at step 411b. Method 400b proceeds from step 410b directly to step 412b if Merchandise 110 is not linked, or proceeds first through step 411b to sever the link if Merchandise 110 has a pre-existing link. At step 412b Merchandise/DMC Pairing Engine 166 links selected DMC with selected Merchandise Registration Code 142x. Finally, at step 414b, Merchandise/DMC Pairing Engine 166 confirms pairing success to Customer Account Database 176 of FIG. 1, and Method 400b ends at step 416b.

FIG. 4C depicts Method 400c for pairing/re-pairing Tokenized DMCs with new/replacement tokenized Merchandise. As with Method 400b, the tokenization of Merchandise 110 identified by means of an NFC or similar technology as depicted by Method 400c of FIG. 4C, which creates a unique individual identifier for the physical object. In one embodiment of the present disclosure, the unique identifier permits the consumer to replace a lost, damaged or retired tokenized item of Merchandise 110 with new or different one, and reassign the DMC that was paired with the original tokenized item to the new tokenized item. Method 400c starts at step 402c and proceeds to step 404c where the consumer with a pre-existing, registered, tokenized DMC purchases or acquires a new/replacement tokenized item of Merchandise 110 of FIG. 1 for that DMC. At step 406c, the consumer proceeds through Method 2H to generate, authenticate and register the new/replacement item of Merchandise 110. At step 408c, the consumer selects the Tokenized DMC/Access Key 165x from Customer Account Database 176 to be paired with the new/replacement item of Merchandise 110. Proceeding to step 410c, the consumer selects Merchandise Registration Code 142x assigned to the new/replacement item of Merchandise 110 from Customer Account Database 176. At step 412c, the consumer submits selected pairing to Customer Account Database 176. At step 414c, Merchandise/DMC Pairing Engine 166 links selected DMC with selected Merchandise Registration Code 142x. Finally, at step 416c, Merchandise/DMC Pairing Engine 166 confirms pairing success to Customer Account Database 176, and Method 400c ends at step 418c.

In one embodiment, Deployment Device 190 (or other device which is part of and compatible with System 100) accesses and authenticates Merchandise Token 142 to ensure that only genuine and compatible Merchandise (i.e. no knockoffs) become a part of System 100. Merchandise 110 may not pass the authentication step if the code associated with Merchandise Token 142 is missing or is counterfeit. At steps 312b, 314d, and 406c for Methods 300b, 300d and 400c respectively, the authentication code initially associated with Merchandise Token 142 (the First Code) changes to a second code (the Registration Code) by means of DAT Module 162 and updates on that basis, with every authentication. Updating and conversion of the First Code associated with Merchandise Token 142 into a Registration Code removes any information chain that might possibly be hacked prior to the authentication, registration and inclusion of Merchandise 110 into System 100, and continues to provide a protocol to sustain this protection by constantly changing the Registration Code with every (or routine) authentication. Only Methods 300b, 300d, and 400c have this level of Merchandise protection, as the means to verify the authenticity of Merchandise 110 is done via Chip Functionality 140.

FIG. 5 depicts Method 500 for transferring DMC licenses from original licensee to new licensee, according to an embodiment of the present disclosure. Method 500 starts at step 502 and proceeds to step 504, where the consumer selects Tokenized DMC/Access Key 165x from Customer Account Database 176. At step 506, LRF 164 notifies 3rd Party Merchant Enabler 130 of consumer's intent to sell selected Tokenized DMC/Access Key 165x. At step 508, 3rd Party Merchant Enabler 130 sells original licensee's Tokenized DMC/Access Key 165x to new licensee. Proceeding to step 510, 3rd Party Merchant Enabler 130 notifies LRF 164 of the sale. At step 512, DAT Module 162 authenticates Tokenized DMC/Access Key 165x. If not authenticated, LRF 164 notifies 3rd Party Merchant Enabler 130 that the sale is void at step 514, and Method 500 ends at step 526. At step 516, if Tokenized DMC/Access Key 165x is authenticated, LRF 164 transfers the purchased Tokenized DMC/Access Key 165x from the original licensee's Customer Token Wallet 178 to Token Transfer Engine 168 of FIG. 1. At step 518, Token Transfer Engine 168 conveys ownership of Tokenized DMC/Access Key 165x from the original licensee to the new licensee. At step 520, LRF 164 transfers Tokenized DMC/Access Key 165x from Token Transfer Engine 168 to the new licensee's Customer Token Wallet 178 of FIG. 1. At step 522, LRF 164 sends confirmation of the completed transaction to 3^{rd} Party Merchant Enabler 130 of FIG. 1. And at step 524, 3^{rd} Party Merchant Enabler 130 settles payment between the original and new licensees, and Method 500 ends at step 522.

In one embodiment, Method 500 details the transfer of DMC, independent of any item of Merchandise 110 to which it may have been anchored. When the transfer is complete, the DMCs Registration Code changes such that the DMC will no longer render upon the merchandise to which it was previously anchored. The transferred DMC is effectively untethered from its previous item of Merchandise 110 and as a result is freed up to be re-tethered by the licensee to another item of Merchandise 110 of the same or different type, depending on parameters set forth by the licensor (e.g. going from a mug to a canvas or to another mug). If the new licensee desires to obtain that DMC's previously anchored item of Merchandise 110, then conveyance of that item may be done through System 100, or through a 3^{rd} Party outside of System 100 such as eBay. Method 500, in effect, creates an authorized secondary marketplace for the transfer of authenticated, licensed digital media content.

In one embodiment, the transfer of DMCs by Method 500 provides a platform which presents a number of benefits. It gives an open market outlet which increases demand and liquidity for genuine licensed Tokenized DMCs. Since the only information that is accessed and used by System 100 for distribution of Tokenized DMCs is the authentication of the Tokenized DMC itself, potentially confidential information, such as purchase history and previous sales price, are not exposed. Furthermore, because the underlying license of the Tokenized DMC exists independent of the item of Merchandise to which it is applied, and does not rely on registration databases for authentication, the DMC license can be authenticated and conveyed through Method 500 by means of Distribution Server 150. In a related embodiment, System 100 may allow the consumer to extract and take possession of the tokens resident in their account from System 100. These extracted tokens may then be kept on the consumer's hard drive or placed on data storage devices (not shown).

According to one embodiment of the present disclosure, the Registration Code of the DMC is updated and reassigned at the time it is rendered upon merchandise providing a unique layer of control and intellectual property protection of the licensed DMC, restricting its unauthorized replication and/or broadcast, and safeguarding the unique intrinsic value of the DMC license property for the content provider and consumer alike. In this way, the system described above creates a controlled, scalable market by offering an online platform to economically sell, resell, activate, protect and manage the use of DMC license properties.

According to one embodiment of the present disclosure, the consumer may subscribe to a Merchandise Media Channel or Jukebox DMC feeds. The DMC provided through the channel may be updated automatically on a daily, weekly or monthly basis, or may be updated on request by the consumer or in a manner that is linked to a payment cycle. The DMC may be provided through the Merchandise Media Channel or Jukebox DMC feed, for a fee or may be provided free-of-charge. In the case of the latter, advertisements and/or links to affiliated websites may be inserted before, during or after play of the DMC to help offset production costs. Rendering the DMC through the assigned Merchandise, enables the Merchandise itself to perform as a media platform.

According to another embodiment of the present disclosure, the image on Merchandise 110 may be customized. It may, for example, depict a specific individual (real or imaginary), and by means of AR, the individual's mouth may be animated to appear as if it were saying or singing a customized message. The mouth may be programmed to move in alignment with standard phonetics so as to best approximate the movements made when any given words are spoken/sung. DMC for these applications may originate via text, or spoken/sung content, or from a drop-down menu indicating approved words such as common names of people as one might find in a selection of keychains and be photo-based or partially or fully animated. The image and voice of the spoken/sung content may be characterizations of a famous/public person or may use vocal recognition and approximation technology to speak/sing the desired message. According to another embodiment, Distribution Server 150 may provide the consumer with a system for managing content-creation rights, allowing multiple parties to submit/push DMCs to Customer Account Database 176 to be rendered on specified items of Merchandise 110 owned by people in their network, under a set rubric of sharing permissions. One embodiment may also include the option to queue and play this content in a desired order, to further customize the AR experience. Further, part of this embodiment includes the consumer's capacity to curate ‘mash-ups’ of various media content, such as rigging faces to sing popular songs, merging video clips in one fashion or another, or splicing together audio and video clips (where the audio doesn't match the original video). This embodiment includes consumer generated graphical and media content to allow for a consumer-driven marketplace where content is created, sold and curated by the consumer.

System 100 provides the consumer with an integrated platform for managing and accessing licensed media content on demand and at their discretion. The system and methods describe above may also be extended to political campaigns, where posters embedded with triggers to deploy media content through AR, would require an authenticated channel to generate, tokenize generate, tokenize and deploy DMCs in the manner described by these and other embodiments. This may be extended to various commercial applications such as tattoos, instructional DMC imposed over objects, (such as status updates on safety, repair notices, or otherwise, of particular use in the educational and medical fields), murals or other artwork, or facial recognition (with overlays or integrations of media content upon faces). These overlays can also be applied to action figures, stuffed animals or physical objects where related DMCs can be appended to the item as integral to the merchandise or equipment, with the physical features of the item being the AR trigger points, in lieu of a GUI.

Subscription DMC refers to an ongoing feed of digital media content. In one embodiment of the present disclosure, rights to the DMC expire after a fixed period of time, at which point a license to the expired content may or may not be offered to the consumer for purchase or extension. In another embodiment, the consumer may pre-purchase a license to the subscription DMC, with rights to archive the DMC in their account for future access indefinitely or for a pre-set period of time In either case, these subscription DMC function as access keys (triggered by the associated graphic which acts as a form of ‘public key’) that are tokenized, where the subscription itself is a discrete token with independent value. Such subscription DMC becomes tradeable (or even leasable), akin to a time-share or a share in a country club.

Further embodiments have pre-tokenized DMC offered on a “batch basis” or “printings” with each batch representing the various editions (1^{st} edition, 2^{nd} edition, etc.) as is seen in the publishing industry. These designations of “printings” et al., afford yet another mechanism for ascribing differentiation, scarcity and value to the DMC, particularly applicable but not limited to collectible DMCs.

Other embodiments include showing excerpts of or “trailers” for the DMC content upon items on the shelf which activate without any secondary authentication but only from Merchandise Profile 122. These would be limited to what amounts to ads for the product as only when the DMC associated with a given item of Merchandise 110 is activated and registered with the owner's account will the DMCs render on those items of Merchandise 110.

Further, the system or methods described above may also be extended to mechanisms which provides temporary “guest access” to allow guests to render the account holder's registered DMCs on the guest's own Deployment Device 190. Guest access may be limited to a specified time period (such as a span of 24 hours) or by physical proximity to the account holder's Deployment Device 190 or registered Merchandise 110 (as might be the case for entertaining guests at one's home or office). In one embodiment, sharing may be governed by GPS or Bluetooth to limit the sharing to a specified location. Or if shared remotely, access may be granted for a limited time only. In another embodiment, access privileges for guests may be added by way of QR codes. A further embodiment of the present disclosure may limit sharing to one guest at a time, with additional guests allowed access for a small fee on a limited basis or for a specified period of time, such as 24 hours. Access may also be granted through social networking permission protocols to allow for private and selective viewing by others of what a given piece of merchandise is set to.

Yet another embodiment has consumers purchasing a disposable token for

DMC access that expires after use or after other limiting factors, such as a specified period of time. By way of example, this could be used for museum tours where DMC may be provided to visitors to enhance their viewing experience through AR. The system or methods described herein rely on authentication tokens which have the potential, in rare cases, for becoming dysfunctional and not passing verification protocols. In one embodiment, in the event of token dysfunction, the dysfunctional token may be swapped for a functional token, which would then be fused with the registered DMC or Access Key formerly associated with the dysfunctional token.

In another embodiment of the present disclosure, the system or methods described herein may permit the consumer to selectively extract and purchase an AR license for a video clip of their choice from any digital media for which rights and access have been granted. This embodiment may include 3^{rd}-party-supplied DMCs but may also specifically include user-created and furnished DMC (e.g.: home videos and clips of one's personal travels or experiences). These DMCs may be individually paired with Merchandise 110 or randomly paired with Merchandise 110 and sequenced in a fashion similar to images played upon desktop computers as “screensavers”. Part of this embodiment includes conventions for safeguarding rights to and use of one's own likeness. It also includes permissions to create personalized merchandise with a real-person's avatar, with methods to cross-check against social media profile authentication methods to prove identity and prevent libel or other character-defaming events. This will put controls in on printing someone's likeness and applying songs or other content to that likeness without proper permissions by the owner of that likeness.

A further embodiment details the sale of an item of Merchandise with a preloaded album of selected Jukebox DMCs. The Merchandise may be an unanchored and themed item of Merchandise 110, with a representative iconic image specifically designed to render Jukebox DMCs within prescribed parameters (e.g.: a sports hero mug featuring an image or caricature of the sports hero, with an album of ten DMCs of that sports hero's most celebrated moments). This embodiment includes Merchandise that is sold with pre-packaged media or with media that is added incrementally post-sale, where the combining of “merchandise with pre-packaged video content” is a product unto itself. As such, any property transfer of this nature could entail the selling of the merchandising rights (DMC token) along with any media associated with that token.

Embodiments of the invention detailed in this disclosure may not be limited to AR-rendered experiences but may also apply to VR-rendered experiences or conventional audio or video playback. In one embodiment, any DMCs in Customer Token Wallet 178 made available for AR rendering, may also be configured to render as a traditional video or audio file directly on Deployment Device 190, bypassing the triggering mechanism of GUI 120 on Merchandise 110.

In another embodiment, distribution of streaming or discrete DMC rendering may also apply to audio DMCs (streaming or otherwise) distributed on the same basis as otherwise detailed in this disclosure. This may entail triggers from Merchandise Token 142 which, following proper authentication, will allow for the rendering of the audio DMC, which may include songs, poetry, quotes, excerpts from speeches, or consumer-generated content of a personalized nature. It may include material converted to audio files though ‘text to voice software’ so as to convert content such as blogs, articles, personal texts, emails, etc., into audio DMC, to be played on designated Merchandise or directly on Deployment Device 190. Such DMC may use software to approximate a specific voice uploaded to System 100, whether consumer-generated or one designed to match that of a notable person for whom license rights of vocal impersonation have been granted.

In another embodiment of the present disclosure, DMC providers may use the system as a primary publishing platform wherein cooperative-copyrights may be granted between the content-creator and System 100's authorized merchandizers or other entities. The resulting copyrighted DMC may be marketed and distributed via System 100 in various ways. In one embodiment these DMCs may be published with an identifying marker or branding superimposed on the front of the DMC (or utilizing some other identifying feature) to designate the origin and ownership of the distributed DMCs, to safeguard against copyright infringement in the event the DMCs are unlawfully distributed through outside video sharing platforms like YouTube. This embodiment facilitates automatic identification of any such infringements, allowing the DMCs to be removed from the offending platform, bypassing the need for continual monitoring of external video-sharing platforms.

System and Methods of the present disclosure allow for the creation and management of media license rights as discrete units that afford content creators novel DRM protocols to monitor and control the disposition and character of licenses on a transparent, controlled and incremental basis, combined with AR rendering protocols, all providing the framework through which content creators can more effectively be compensated for hard-to-monetize media microcontent. The technique described herein provides consumer access to DMC in a way that is novel, flexible, interactive and valuable and can be deployed so as to create a direct, elective channel between influencers, streamers or content creators (as found on platforms such as YouTube, Vimeo, Steam, Twitch, Twitter, Instagram, Snapchat, Pinterest, Facebook, and the likes) and their followers. It may be appreciated that the inability to incrementally compensate content creators for their intellectual property, as it is consumed, forces advance payouts of royalties, inhibiting the consumer from on-demand, consumer-created and curated AR merchandise, by making it unfeasible and impractical. The technique described herein also provides manufacturers with a centralized management system for DRM to ensure compliance with intellectual property (copyright) laws while assuring content creators that their license royalties are incrementally and indelibly tracked. This can include website plug-ins or other interface to manage various aspects of DRM, such as the authentication of merchandising rights (either to the graphic itself, or to the graphic as a trigger which serves to access video content via AR). This mechanism allows custom merchandise companies the assurance that the manufacture of that item is legally or otherwise sanctioned.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. That memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, and/or various other storage mediums capable of storing that contain or carry instruction(s) and/or data.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1. (canceled)

2. A method for management of digital media content (DMC), comprising:
providing, in a deployment device, a token having a unique digital identity associated with at least one static or dynamic DMC;
authenticating, using non-cryptographic, distributed authentication in a digital authentication technique module, the provided token to generate a DMC registration code for the at least one static DMC;
activating, in a distribution server, a license for the at least one static or dynamic DMC corresponding to the generated DMC registration code;
in response to activation of the license, in a token fusing module:
unless the token includes a merchandising right for the at least one static or dynamic DMC corresponding to the generated DMC registration code, generating said merchandising right and any access key for the at least one dynamic DMC, and
updating the generated merchandise right and any access key for the at least one DMC to the token while recording the access key in at least one of the distribution server or a cloud server;
receiving, from one of either the deployment device or distribution server, a merchandise profile associated with merchandise;
in the event merchandising profile data is not included in the token, then assigning, in a merchandise/DMC pairing engine, a merchandise token to the merchandise based on the corresponding merchandise profile;
one of either authenticating, in the digital authentication technique module, the merchandise token to generate a merchandise registration code for the merchandise, or in the absence of a merchandise token, generating, in the merchandise/DMC pairing engine, the merchandise registration code associated with the merchandise profile;
updating, in the token fusing module, the generated merchandise registration code for the merchandise to the token and recording the generated merchandise registration code in one of either the distribution server or cloud server; and
anchoring, in at least one of the merchandise/DMC pairing engine or cloud server, the access key associated with the at least one DMC to the merchandise registration code associated with the merchandise.

3. The method according to claim 2 further comprising:
registering, in the token fusing module, one or more merchandise rights and any associated access keys for corresponding multiple DMCs to the token; and
using the token fusing module to update data on one or more of the merchandise rights and any associated access keys to selectively assign the one or more of the merchandise rights or keys to the merchandise registration code associated with the merchandise therefor.

4. The method according to claim 2 further comprising:
recognizing, in the deployment device, the merchandise profile associated with the merchandise;
retrieving, in the deployment device or distribution server, a validation of a discrete merchandise right to any DMC as well as any associated access key for the at least one DMC anchored with the merchandise registration code associated with the merchandise having the recognized merchandise profile; and
rendering, in the deployment device, the at least one DMC in response to the retrieval of any access keys thereof.

5. The method according to claim 4, wherein the at least one DMC is periodically updated, and wherein the method further comprises rendering, in the deployment device, the updated at least one dynamic DMC based on the retrieval of the access key thereof.

6. The method according to claim 4 further comprising:
allowing, in the deployment device, the consumer to select a subset of the at least one DMC having the access key registered therewith;
allowing, in the deployment device, the consumer to generate a guest access key for the selected subset of the at least one DMC;
sending the guest access key to a further deployment device; and
rendering, in the further deployment device, the selected subset of the DMC in response to retrieval of the guest access key.

7. The method according to claim 6, wherein the rendering of the selected subset of the at least one DMC is limited by one or more of physical proximity of the deployment device, social network permissions and time limit on rendering of the selected subset of the at least one DMC.

8. (canceled)

9. The method according to claim 2 further comprising allowing, in the deployment device or distribution server, removal of the anchoring of the access key associated with the at least one DMC to the merchandise registration code associated with the merchandise.

10. The method according to claim 9 further comprising allowing, using the deployment device and distribution server, the transfer of the token and associated merchandise right and access key associated with the at least one DMC, as removed from the anchoring to the merchandise registration code associated with the merchandise, to be anchored to another merchandise registration code associated with another merchandise using merchandise/DMC pairing engine.

11. The method according to claim 4 further comprising:
anchoring, in the merchandise/DMC pairing engine, multiple access keys associated with corresponding DMCs to the merchandise registration code associated with the merchandise for the consumer; and
queuing, in the deployment device, the DMCs, as associated with the multiple access keys, in a desired order to be rendered in response to the retrieval of the multiple access keys thereof.

12. The method according to claim 2, further comprising triggering, in a DMC/access cloud server, payment to a creator/owner of the at least one DMC based on the activated license for the at least one DMC.

13. (canceled)

14. The method according to claim 4, wherein the rendering of the at least one DMC is in the form of one or more of Augment Reality (AR) rendering on the merchandise, and audio or video rendering on or off the merchandise.

15. The method according to claim 14, wherein the rendering of the at least one DMC is in the form of dynamic alteration of visual countenance of the merchandise through digital overlays, such that the rendering dynamically alters and regulates the visual countenance of the merchandise.
